(19) United States
(12) Patent Application Publication
(10) Pub. No.: US 2006/0170285 A1
(43) Pub. Date: Aug. 3, 2006

(54) Data transmission system and data transmission method

(76) Inventors: Kazuya Morimitsu, Ibaraki-shi (JP); Makoto Ubukata, Ikoma-shi (JP); Tetsuhiro Maeda, Kadoma-shi (JP); Masao Kiba, Suita-shi (JP); Akio Kurobe, Tondabayashi-shi (JP)

Correspondence Address: RATNERPRESTIA, P.O. BOX 980, VALLEY FORGE, PA, 19482, US

(21) Appl. No.: 11/329,840

(22) Filed: Jan. 11, 2006

(30) Foreign Application Priority Data
Jan. 13, 2005 (JP) 2005-005915
Jul. 1, 2005 (JP) 2005-194406

(51) Int. Cl. H02J 3/02; B60L 1/00; H04L 5/16; G05B 11/01; G08B 1/08

(52) U.S. Cl. 307/3; 307/10.1; 340/310.11; 375/222; 375/220; 340/538.11

(57) ABSTRACT

The present invention includes an electric wire laid in cars, a PLC modem connected with each electric wire and a terminal connected with each PLC modem. The terminal can communicate through the electric wire by using the PLC modem. When the cars are coupled with each other, the electric wires are electrically connected with each other and a new address is allocated to a control unit which has a unique address provided for each terminal.

### BACKGROUND OF THE INVENTION

1. Field of the Invention

The present invention relates to a data transmission system and a data transmission method for a transporting vehicle. The present invention relates to a data transmission system and a data transmission method between cars of a railway, a subway or the like, or inside a bus, an airplane, a ship or the like.

Alternatively, the present invention relates to a system of transmitting data between rooms in a liner or the like.

2. Related Art of the Invention

Various types of announcement on board a train or image information services using laid lines have been provided as a service inside cars of a railway, a subway or the like. For example, the services include an audio service on a train or image information service to announce “This train is going to set out **:** bounding for ***.” or “The next stop is ***.”, for example, by using a display device such as a liquid crystal panel or the like. Image and audio information services like those in an airplane will be provided as improvement of railway services.

Conventional data transmission systems between railway cars will be described.

FIG. 21 is a schematic view showing a system configuration of a conventional data transmission system between railway cars.

In the data transmission system between railway cars of the railway cars 70, the railway cars 70 include a front car 100, intermediate cars 110 consisting of some cars, and a back car 120 at the end. Each car is connected with laid lines 74 represented as a communication line for transmitting image and audio information data, a control line for switching train type indications indicating the destination, limited express/express or the like or for controlling lights and air-conditioners, and an electric wire for supplying power to lights or the other appliances, via each coupling section 75 at each car.

Laid lines 74 including a communication line, a control line and an electric wire drawn in each car are connected with a camera for taking a picture of passengers on board or at a platform, a monitor for displaying an image taken by the camera, a Communication Control Unit (CMC) as a source of announcement on board or various types of image and audio services, and a railway wireless device of communicating between trains or with a control center on the ground for each usage as various types of terminals 76, 77 and 78.

FIG. 22 is an example of a display unit inside a car 79 set in a car for providing various image and audio information services for passengers. Usage of the services includes information on a destination of the train, stops, delay of the train, the arrival time or the current position of the train, distribution of contents such as a film for the purpose of entertainment, advertisements for commercial purposes, and announcement on board the train including an image.

FIG. 23 is also an example of a display unit inside a car 80 set in a car for providing information services for passengers in characters (for example, disclosed in Japanese Patent Laid-Open No. 7-508609).

Information to be displayed on the display unit inside a car 79 or 80 or audio information such as announcement on board a train is transmitted to each car from a CMC through a communication line of the laid lines 74.

A communication method of an electric wire carrier modem to connect with a network outside a car through a power cable is also proposed, though it is not a communication between railway cars (for example, disclosed in Japanese Patent Laid-Open No. 11-317697).

The conventional data transmission method in a transporting vehicle, however, was not able to transmit a large amount of data. In order to transmit a large amount of data, a communication line for transmitting the large amount of data needs to be newly added to an existing communication line and the like.

For example, a data transmission rate of the E1 (European standard of high speed digital transmission (bit rate=2.048 Mbps)) communication or the LON communication mainly used for a communication inside a train ranges from some hundreds Kbps to some Mbps. Therefore, a large amount of data which requires a transmission rate more than the above transmission rate was not able to be transmitted through an existing communication line. In order to transmit a large amount of data, operation and costs for setting a communication line for high-speed communication which connects cars anew are required.

A large amount of data is also required to be transmitted with high speed and real time transmission between cars. If a large amount of data can be transmitted between cars, image data inside running cars taken by television cameras can be used for security purpose inside cars as the data is played and monitored in a cock pit in the front car or sent by wire or wirelessly to a control center on the ground and displayed on a monitor or the like at the control center. Image data for passengers to watch can also be distributed. As such, a large amount of data has been required to be transmitted between cars.

The present invention intends to provide sophisticated image and audio information service or the like, by realizing a PLC communication by using an electric line laid on cars.

The present invention also intends to provide sophisticated image and audio information service because it can easily establish a high-speed high-bandwidth digital data transmission communication network by using existing laid lines such as an electric wire.

The present invention also intends to provide a data transmission system and a data transmission method which solve the above mentioned conventional problems and enable a large amount of data such as image data to be transmitted.

### SUMMARY OF THE INVENTION

The 1^{st} aspect of the present invention is a data transmission system comprising:

an electric wire provided in a car;

a PLC modem connected with said electric wire; and

a terminal connected with said PLC modem;

wherein said terminal can communicate through said electric wire by using said PLC modem.

The 2^{nd} aspect of the present invention is the data transmission system according to the 1^{st} aspect of the present invention,

wherein said system comprises a plurality of said cars, a plurality of said PLC modems and a plurality of said terminals;

further comprising a control unit with a unique address, provided for each of said terminals; and

wherein, when said cars are coupled with each other, said electric wires are electrically connected with each other and a new address is allocated to each of said control units.

The 3^{rd} aspect of the present invention is the data transmission system according to the 2^{nd} aspect of the present invention, wherein, when said cars are coupled with each other, said new address is automatically allocated to each of said control units by making any one of said control units as a master and the other control units as slaves according to a predetermined rule.

The 4^{th} aspect of the present invention is the data transmission system according to the 2^{nd} aspect of the present invention, wherein, when said cars are coupled with each other, a predetermined particular control unit assumes a server function and automatically allocates a new address to each of the other control units.

The 5^{th} aspect of the present invention is the data transmission system according to the 2^{nd} aspect of the present invention, wherein electrical connection between said electric wires in said plurality of cars is automatically completed.

The 6^{th} aspect of the present invention is a data transmission system comprising:

a line made of at least a single system of metal line provided in separated plural rooms;

two or more terminals of providing an image and audio information service for said rooms; and

a converting adapter connected between said line and said terminals; wherein said converting adapter modulates data into digital signals as electronic signals, sends the digital signals through said line when said data is sent from said terminals; and demodulates said digital signals and distributes said data to said terminals when said data is received.

The 7^{th} aspect of the present invention is the data transmission system according to the 6^{th} aspect of the present invention, wherein said line is an electric wire laid in each car of a railway.

The 8^{th} aspect of the present invention is the data transmission system according to the 6^{th} aspect of the present invention, wherein said separated rooms are railway cars.

The 9^{th} aspect of the present invention is the data transmission system according to the 6^{th} aspect of the present invention, wherein said converting adapter is a PLC (Power Line Communications) modem.

The 10^{th} aspect of the present invention is the data transmission system according to the 6^{th} aspect of the present invention, further comprising:

a converter of converting or inverting plural systems of signals into a single system of signals;

a PLC modem;

a connecting section of connecting said converter and said plural systems of signals.

The 11^{th} aspect of the present invention is the data transmission system according to the 9^{th} aspect of the present invention, comprising:

the line including a communication line, a control line and an electric wire;

the PLC modem of superimposing a signal on said electric wire of said line; and

a connecting section of connecting said electric wire of said line and an electric wire of the other car through which a PLC signal flows.

The 12^{th} aspect of the present invention is the data transmission system according to the 9^{th} aspect of the present invention, further comprising:

a PLC wireless signal converter connected to a line through which a PLC signal flows; wherein said PLC wireless signal converter separates a superimposed PLC signal and converts the PLC signal into wireless waves, or to the contrary receives wireless waves, converts the wireless waves into a PLC signal and superimposes the PLC signal on the line; and

an antenna of sending and receiving a wireless wave.

The 13^{th} aspect of the present invention is the data transmission system according to the 9^{th} aspect of the present invention, further comprising a wireless access point connected with said PLC modem, wherein said wireless access point relays between a wireless communication device and said PLC modem.

The 14^{th} aspect of the present invention is a data transmission system in a transporting vehicle comprising:

a plurality of transmitting units; and

a plurality of receiving units corresponding to said plurality of transmitting units, respectively;

wherein a first communication between a transmitting unit and a receiving unit corresponding to said transmitting unit is performed by using a frequency different from that of a second communication and by at least partially using the same cable, the second communication being between another transmitting unit and a receiving unit corresponding to said other transmitting unit.

The 15^{th} aspect of the present invention is the data transmission system according to the 14^{th} aspect of the present invention, wherein

said same cable is a laid line made of a metal line;

said second communication is a predetermined communication using said laid line;

said first communication is a communication using a plurality of carrier frequencies through said laid line; and

a modem for a first communication is provided between said transmitting unit and said laid line and between said receiving unit corresponding to said transmitting unit and said laid line.

The 16^{th} aspect of the present invention is the data transmission system according to the 15^{th} aspect of the present invention,

wherein said first communication is a PLC communication (Power Line Communications); and

wherein a modem for said first communication is a PLC modem.

The 17^{th} aspect of the present invention is the data transmission system according to the 16^{th} aspect of the present invention,

wherein said second communication is a E1 communication;

wherein said other transmitting unit and said receiving unit corresponding to said other transmitting unit are respectively connected with said laid line via a low-pass filter of reducing frequency bands used for a PLC communication; and

wherein each of said PLC modems is connected with said laid line via a high-pass filter of reducing frequency bands used for a E1 communication.

The 18^{th} aspect of the present invention is the data transmission system according to the 16^{th} aspect of the present invention,

wherein said second communication is an E1 communication; and

wherein said PLC communication is performed by using frequency bands unused for said E1 communication.

The 19^{th} aspect of the present invention is the data transmission system according to the 16^{th} aspect of the present invention, wherein said PLC modem connected with said transmitting unit determines frequency bands used for said second communication based on information of a header part of packet data received in said PLC communication, then performs said PLC communication by using frequency bands other than said bands used for said second communication.

The 20^{th} aspect of the present invention is the data transmission system according to the 15^{th} aspect of the present invention, wherein said first communication is performed by using predetermined frequency bands except for fixed bands used for said second communication.

The 21^{st} aspect of the present invention is the data transmission system according to the 15^{th} aspect of the present invention, wherein said second communication is performed by using frequency bands unused for said first communication.

The 22^{nd} aspect of the present invention is the data transmission system according to the 14^{th} aspect of the present invention,

wherein said same cable is a laid line made of a metal line;

wherein said second communication is an analog audio communication using said laid line;

wherein said first communication is a communication of transmitting over a plurality of modulated carrier frequencies using said laid line; and

wherein a modem for a first communication is provided between said transmitting unit and said laid line and between said receiving unit corresponding to said transmitting unit and said laid line, respectively.

The 23^{rd} aspect of the present invention is a data transmission system comprising:

a plurality of transmitting units;

a plurality of receiving units corresponding to said plurality of transmitting units respectively;

the same cable to which all of said plurality of transmitting units and said plurality of receiving units are connected;

a modem provided between a transmitting unit and said same cable; and

another modem provided between a receiving unit corresponding to said transmitting unit and said same cable; and

wherein a first communication between said transmitting unit and said receiving unit corresponding to said transmitting unit is performed by using frequency bands other than a plurality of discontinuous bands used for a second communication between an other transmitting unit and a receiving unit corresponding to said other transmitting unit.

The 24^{th} aspect of the present invention is the data transmission system according to the 23^{rd} aspect of the present invention, wherein said bands used by said first communication is predetermined bands except for fixed bands used for said second communication.

The 25^{th} aspect of the present invention is a data transmission method in a transporting vehicle,

wherein a first communication between a transmitting unit and a receiving unit corresponding to said transmitting unit is performed by using a frequency different from that of a second communication and by at least partially using the same cable, the second communication being between another transmitting unit and a receiving unit corresponding to said other transmitting unit.

The 26^{th} aspect of the present invention is a data transmission method comprising:

a plurality of transmitting units;

a plurality of receiving units corresponding to said plurality of transmitting units respectively;

the same cable to which all of said plurality of transmitting units and said plurality of receiving units are connected;

a modem provided between a transmitting unit and said same cable; and

another modem provided between a receiving unit corresponding to said transmitting unit and said same cable;

wherein a first communication between said transmitting unit and said receiving unit corresponding to said transmitting unit is performed by using frequency bands other than a plurality of discontinuous bands used for a second communication between another transmitting unit and the receiving unit corresponding to said other transmitting unit.

### BRIEF DESCRIPTION OF THE DRAWINGS

FIG. 1 is a schematic view showing a system configuration of a data transmission system between railway cars according to a first embodiment;

FIG. 2 is a schematic view showing a system configuration of a data transmission system between railway cars according to a second embodiment;

FIG. 3 is a schematic view showing a system configuration of a data transmission system between railway cars according to a third embodiment;

FIG. 4 is a schematic view showing a system configuration of the data transmission system between railway cars according to the third embodiment;

FIG. 5 is a schematic view showing a system configuration of a data transmission system between railway cars according to a fourth embodiment;

FIG. 6 is a schematic view showing a system configuration of a data transmission system between railway cars according to a fifth embodiment;

FIG. 7 is a schematic view showing a system configuration of a data transmission system between railway cars according to the fifth embodiment;

FIG. 8 is a block diagram of a large amount of data transmission system between railway cars according to sixth to eighth embodiments of the present invention;

FIG. 9A is a diagram showing an example of a configuration of the PLC converting module according to the sixth embodiment of the present invention;

FIG. 9B is a diagram showing another example of a configuration of the PLC converting module according to the sixth embodiment of the present invention;

FIG. 10 is a block diagram showing a part of the large amount of data transmission system according to the sixth embodiment of the present invention;

FIG. 11 is a schematic diagram showing an allocation of frequencies used for the E1 communication and the PLC communication in the large amount of data transmission system according to the sixth embodiment of the present invention;

FIG. 12 is a schematic diagram showing an allocation of frequencies used for the analog audio communication and the PLC communication in the large amount of data transmission system according to the sixth embodiment of the present invention;

FIG. 13 is a block diagram of a part of a large amount of data transmission system according to seventh to ninth embodiments of the present invention;

FIG. 14 is a schematic diagram showing an example of frequency bands used for the E1 communication according to the seventh and eighth embodiments of the present invention;

FIG. 15 is a schematic diagram showing an allocation of frequencies used for the E1 communication and the PLC communication in the large amount of data transmission system according to the seventh and eighth embodiments of the present invention;

FIG. 16 is a schematic diagram showing an example of the frequency bands used for the PLC communication according to the ninth embodiment of the present invention;

FIG. 17 is a schematic diagram showing an allocation of frequencies used for the PLC communication and the other communication in the large amount of data transmission system according to the ninth embodiment of the present invention;

FIG. 18 is a block diagram of the large amount of data transmission system according to the ninth embodiment of the present invention;

FIG. 19 is a schematic diagram showing an allocation of frequencies used for the E1 communication and the PLC communication in the large amount of data transmission system according to the ninth embodiment of the present invention;

FIG. 20 is a schematic view of a system configuration of a data transmission system between railway cars according to a tenth embodiment of the present invention;

FIG. 21 is a schematic view showing a system configuration of a conventional data transmission system between railway cars;

FIG. 22 is a diagram showing an example of a display unit inside a car set in a conventional car; and

FIG. 23 is a diagram showing another example of a splay unit inside a car set in a conventional car.

### DESCRIPTION OF SYMBOLS

4 laid line (electric wire+PLC signal)
5 coupling section
6 relay
7 PLC modem
8 various terminals
9 various types of broadband terminal
10 existing car
11 newly constructed car
12 converter
13 connecting section
14 PLC wireless converter
15A, 15B antenna
16 base station
17 existing network
18 station, railway carriage house, vehicle, network destination including a home
19 access point
20 cellular phone
21 PC (personal computer)
22 laid line (for applying to an existing car) (communication line/control line/electric wire)
31, 32 an example of a display unit inside a car
100 front car
110 intermediate car
120 back car
130 E1 communication line
140 relay
150 coupling section
170, 180, 190, 200, 210, 220, 230, 240, 250, 260, 270, 600, 610, 620, 630, 680, 690 PLC converting module
28, 29, 30, 31, 32, 33 monitoring camera
34, 35 server
36, 37 CCTV (Closed Circuit Television) monitor
38, 39, 40 DVR
41 A/D (Analog/Digital) converter
42, 45 encoder
43 UDP/IP (User Datagram Protocol/Internet Protocol) converter
44 PLC modem
50, 51 CMC
52, 53, 54, 55 LPF (Low Pass Filter)
56, 57, 58, 59 HPF (High Pass Filter)
64 transmitter
65 receiver
66 large amount of data transmitting unit
67 large amount of data receiving unit
90 cable
1004 coupling section
1006 relay
1010 laid line
1012 terminal
1013 control unit

### PREFERRED EMBODIMENTS OF THE INVENTION

### First Embodiment

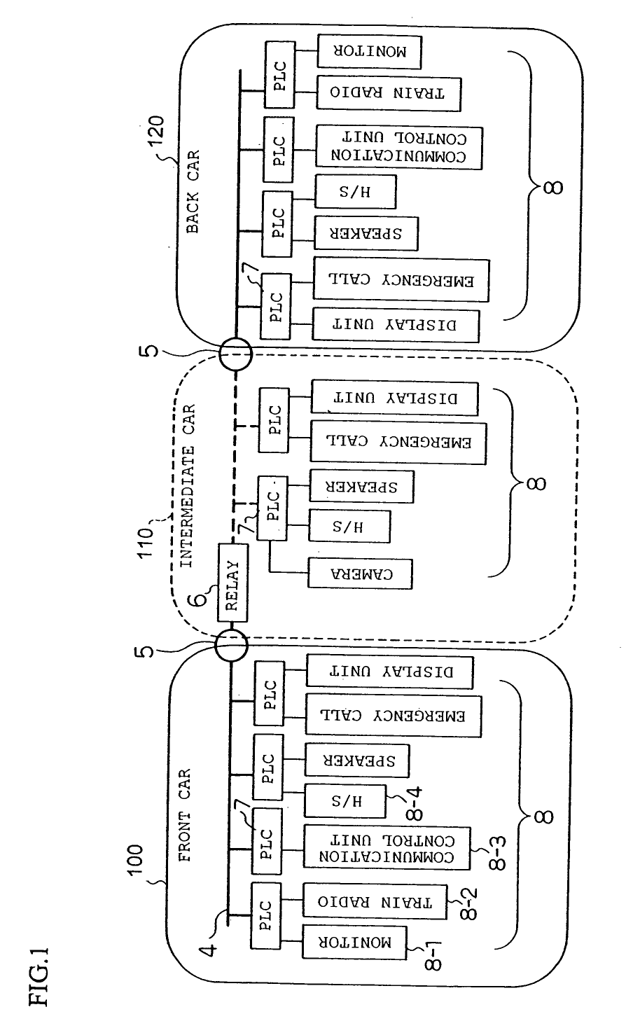

FIG. 1 is a schematic view showing a system configuration of a data transmission system between railway cars according to a first embodiment of the present invention.

In the data transmission system between railway cars, railway cars generally includes a front car 100, intermediate cars 110 consisting of some cars, and a back car 120 at the end. A laid line 4, which is represented as an electric wire for supplying power to each car, is connected through the cars via relays 6 placed near coupling sections 5 of the respective cars.

PLC (Power Line Communications) modems 7 are set on the laid line 4, which is represented as an electric wire drawn in the cars. Various terminals 8 are connected with the laid line 4 via the PLC modems 7. The various terminals 8 include a camera for taking a picture of passengers inside a car or on a platform or a flow of passengers in a station, a monitor for displaying an image taken by the camera, a Communication Control Unit as a source of announcement on board a train or various types of image and audio services, or a train wireless device of communicating between trains or with a control center on the ground. The PLC is a technique for utilizing an existing electric wire as a communication line (Power Line Communication). The PLC modem is a communication adapter for connecting a personal computer or the like to an electric wire for communication. The H/S (Hand Set) terminal 8-4 shown in FIG. 1 is a handset dedicated for a train attendant.

Operation of the data transmission system between railway cars with the above mentioned configuration will be described.

An electric wire for driving lights and display units is necessary for each car of a train. Power is supplied to each car via the relay 6 at the coupling section 5 of each car. By using the electric wire as a communication infrastructure as it is, a communication network can be easily established without requiring a new cable or the like to be set. As the electric wire is generally a direct current or an alternate current of dozens Hz, only a small part of frequency band carried by a copper line is used. Therefore, quite a wide band from 1 KHz to hundreds MHz, that is, low frequency band such as dozens of MHz, can be used so that digital signals can be superimposed on the electric wire and communicated.

The electric wire set in each car as a laid line 4 is connected with a PLC modem 7. The PLC modem 7 is a data modulator/demodulator of digital data for a PLC communication. When the PLC modem 7 sends data, it adds an error correction code to data converted into digital data from each terminal, performs process such as for packetizing the data and superimposes and combines the packets to the electric wire.

A monitor 8-1 and a train radio 8-2, which are terminals 8 inside the front car 100 of FIG. 1, are connected with a single PLC modem 7.

If a plurality of terminals 8, 8 are connected with a single PLC modem 7 like this, the PLC modem 7 packetizes digital data, time-division multiplexes the packetized data and superimposes the data on the electric wire.

When the PLC modem 7 receives data, to the contrary, the PLC modem 7 separates the time-division multiplexed digital signals from the electric wire by a splitter constructed in the PLC 7, demodulates data such as error-correction or the like and separates the demodulated data among respective terminals 8 and transmits the data.

A terminal 8, which deals with an analog signal, can be realized by adding an analog/digital converter (A/D converter) for sending data and a digital/analog converter (D/A converter) for receiving data to the terminal 8 or by allowing the PLC modem 7 to include a D/A converting function.

Although the PLC modem 7 is adapted to have a function of time-division multiplexing packetized data and a function of separating the time-division data into packets when a plurality of terminals 8, 8 are connected with a single PLC modem 7 in the above description, an apparatus with functions of time-division multiplexing sent data and of separating received data may be provided separately from the PLC modem 7.

According to the first embodiment as mentioned above, in a transmission system for transmitting data between cars of railways or subways, an existing line such as an electric wire for supplying power to existing lights can be used without requiring various types of dedicated lines such as a communication line for transmitting image and audio information data to each car, a control line for switching train type indication such as the destination, limited express/express or the like or controlling lights and air-conditioner, and a line for communicating signals from various sensors such as a temperature sensor and a pressure sensor to be set. As a result, according to the first embodiment, a high-speed high-bandwidth communication network can be easily established. This can integrate a broadcasting function, a calling function, an emergency calling function and a guide display function, and simplify communication lines system for facilitating maintenance and management.

It is advantageous to apply the first embodiment to railway cars in that the embodiment uses a low-resistant copper line is used for an electric wire in cars in view of energy transmission efficiency, and in that a high frequency digital signal seldom affects transmission in a car as electronic wave leakage while the train is running as a train body is generally covered with metal such as iron or lightweight aluminum alloy.

### Second Embodiment

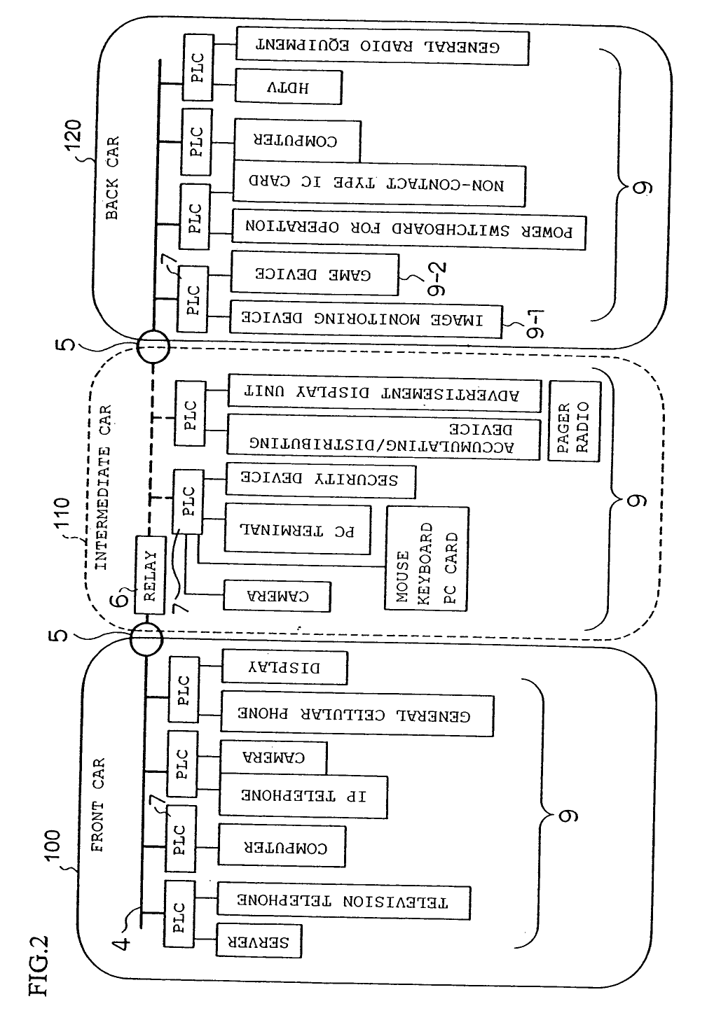

FIG. 2 is a schematic view showing a system configuration of a data transmission system between railway cars according to the second embodiment of the present invention.

FIG. 2 is different from FIG. 1 in that each terminal 9 is a broadband type terminal which requires higher speed higher bandwidth digital transmission than that of each terminal 8 of FIG. 1.

If a game device 9-2 for providing a motion picture is used as a terminal, the device requires several Mbps—dozens of Mbps band to provide a video game in a smooth moving picture for a passenger. Communication employing the PLC is said to enable data communication in several Mbps—hundreds Mbps. Thus, in view of this, the second embodiment can also be sufficient for a terminal which requires high speed and large amount of data for digital transmission.

Here, the PLC has reliability fulfilling a railway requirement of RAMS (Reliability, Availability, Maintainability, Safety). As the PLC has a feature of adapting to any type of lines, it can be flexibly adapted to various conditions such as a strict railway condition requiring a closed wired circuit, a restriction on using existing wiring materials for railways, a condition requiring lines being flame-resistant or a restricted condition of wiring layout for narrow space.

As the PLC can transmit a signal by a plurality of carrier wave signals which are digital modulated to a high density by using a low frequency band appropriate for any railway wirings, transmission in a high speed large volume (190 Mbps) can be realized.

For wiring in a railway car, its noise level is lower than that of a general house by 15-20 dB, and an impedance is around 100Ω, higher than that of a general house. As the wiring in a railway car is stable as such, it is optimal as a transmission medium for the PLC.

The PLC can flexibly adapt to a network in a fundamental part of a train for an existing car, a newly constructed car, system inside a car, system between cars, a coupling section, car devices, a power switchboard, a junction box, a connector and the like.

The PLC enables a single wire to supply power to each device in a train and to perform high speed transmission of a large amount of signals at the same time.

As mentioned above, the second embodiment can realize so-called broadband network inside a railway car and between railway cars. The second embodiment can construct a system for broadcasting, information and advertisement distribution and security service. Accordingly, the second embodiment can provide more sophisticated image and audio information service for a passenger service on a railway. The second embodiment also facilitates communication between a railway car and a base station such as a station among a control center and a plat form and a station.

### Third Embodiment

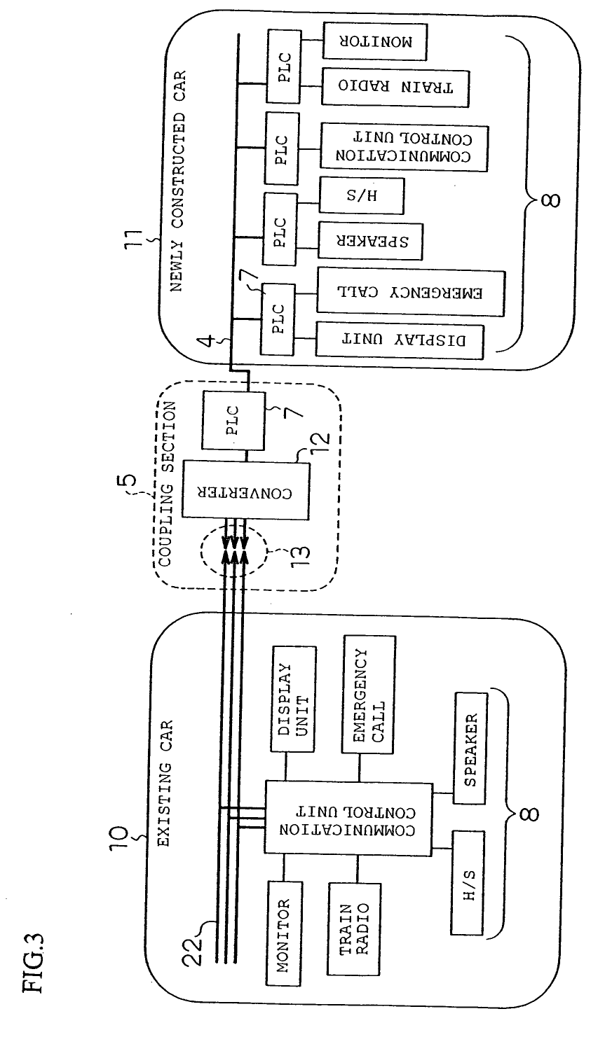

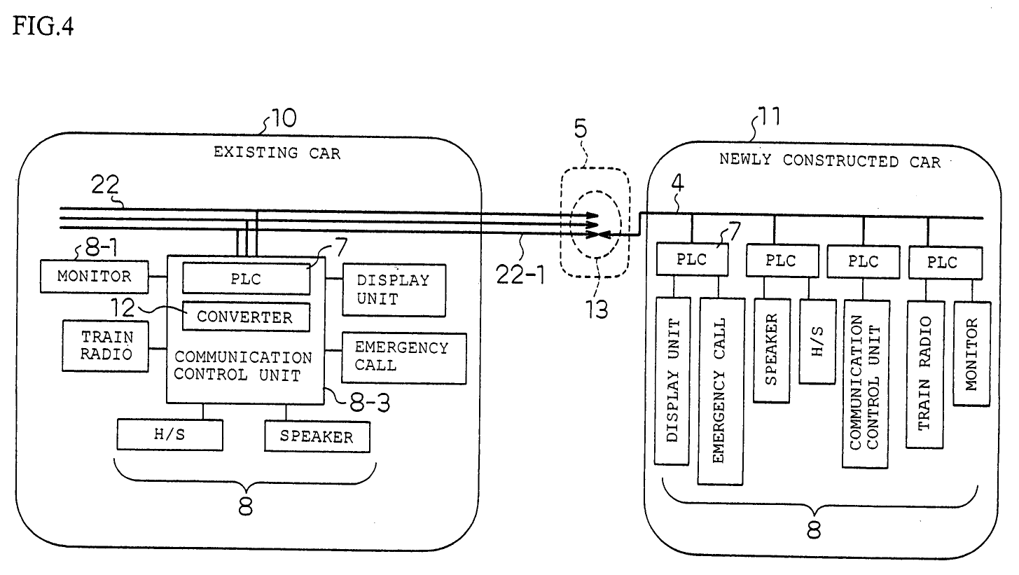

Each of FIGS. 3 and 4 is a schematic view showing a system configuration of a data transmission system between railway cars according to a third embodiment of the present invention.

Each of FIGS. 3 and 4 shows a form of connecting, a conventional model existing car 10, which employs transmission for mainly transmitting analog signals, and a newly constructed car 11, which employs the above mentioned PLC.

In FIG. 3, a converter 12 and a PLC modem 7 are placed near a coupling section 5 of the newly constructed car 11. A conventional model laid line (communication line/control line/electric wire) 22 from the existing car 10 and a laid line (electric wire+PLC signal) 4 at the newly constructed car are connected at a connecting section 13.

A signal from the existing car 10 is outputted from a communication line or a control line and inputted into a converter 12. The inputted signal is converted at the converter 12 into digital data adequate for the PLC modem 7. The digital data is added with an error correction code at the PLC modem 7 and packetized, then superimposed and combined with the electric wire.

In this way, the embodiment enables the existing car 10 which employs conventional transmission and the newly constructed car 11 which employs the PLC to coexist and operate.

An example of FIG. 4 is a modification of the embodiment shown in FIG. 3.

In the example of FIG. 4, a Communication Control Unit 8-3, which is one of various terminals 8, is a device of intensively processing an image, an audio signal or a display signal. The Communication Control Unit 8-3 has a built in converter 12 and a built in PLC modem 7. The other terminals 8 such as a monitor 8-1 are connected with the Communication Control Unit 8-3.

As in the embodiment in FIG. 3, the Communication Control Unit converts a signal from each terminal 8 into a digital signal at the built in converter 12, further processes the digital signal, and superimposes and combines it with an electric wire 22-1 at the limit in PLC modem 7.

A coupling section 5 of a newly constructed car 11 may have a connecting section 13 so that only an electric wire among laid lines 22 can be drawn into from the existing car 10.

The embodiment can be realized by integrating a built in converter 12 and a built in PLC modem 7 into the above mentioned intensive Communication Control Unit set in the conventional model existing car 10.

Alternatively, the embodiment can be realized by changing the conventional Communication Control Unit with a new Communication Control Unit with an embedded in converter 12 and a built in PLC modem.

A communication line and a control line of laid lines 22 of the existing car 10 are kept disconnected with an electric wire of the newly constructed car 11.

In this manner, the embodiment of FIG. 4 enables the conventional existing car 10 and the newly constructed car 11 which employs the PLC to coexist and operate as in the embodiment of FIG. 3.

### Fourth Embodiment

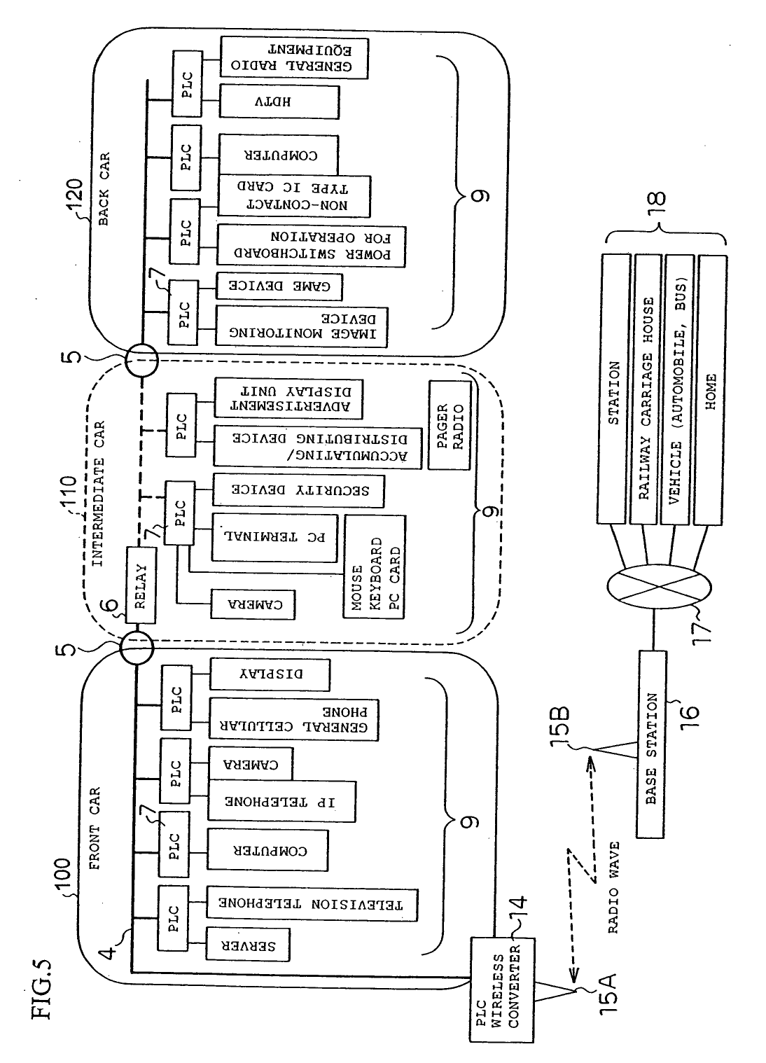

FIG. 5 is a schematic view showing a system configuration of a data transmission system between railway cars according to a fourth embodiment of the present invention.

In the fourth embodiment of FIG. 5, a PLC wireless signal converter 14, which separates a PLC signal superimposed on an electric wire of laid lines 4 and converts the PLC signal into a wireless wave, or which to the contrary receives a wireless wave, converts the wireless wave into a PLC signal and superimposes it on an electric wire, and an antenna 15A which sends and receives a wireless wave are set in a railway car.

The fourth embodiment realizes a communication service between the car and a facility fixed outside the car or a vehicle. That is to say, the fourth embodiment can realize communication with a facility 18 including a station, a railway carriage house, a vehicle such as an automobile or a bus, and a house by using a base station 16 with an antenna 15 for sending and receiving wireless waves and a network 17 connected with the base station 16.

For example, a passenger in a car 100, 110, or 120 can be provided services in such as ticket reservation for changing trains by a service station of a railway station.

The fourth embodiment can broaden usage of the present invention by enabling a communication network inside a railway car and outside entity to communicate with each other by wireless wave so that a passenger can remote control networked consumer electronics at the house from a car, for example.

Although the communication between the PLC wireless signal converter 14 and the base station 16 has been described as communication by wireless wave here, the communication can be the PLC or the other wired communication unit using a wire or a rail.

### Fifth Embodiment

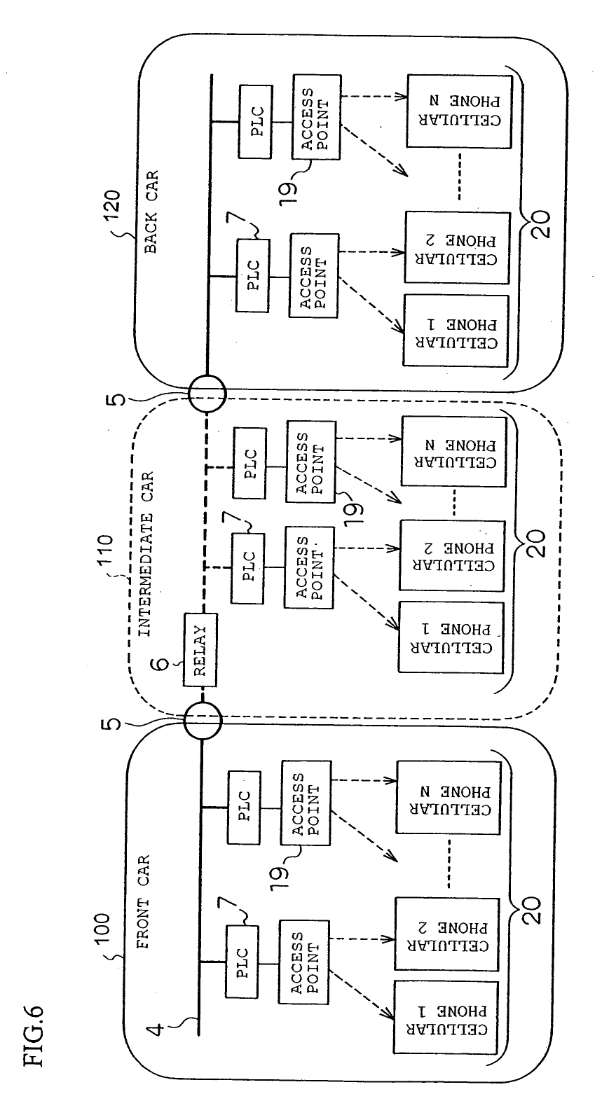

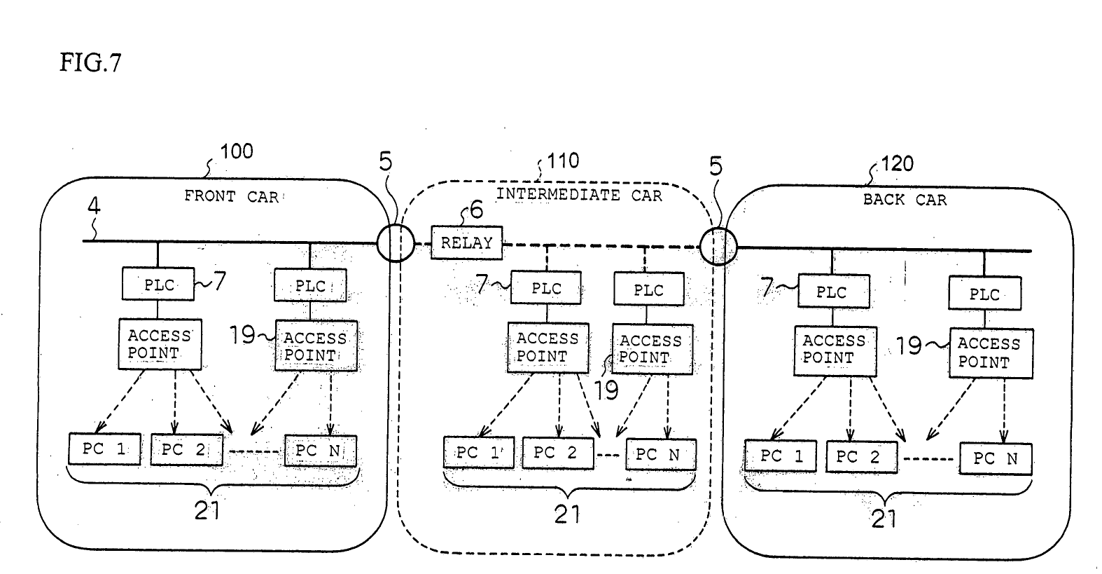

Each of FIGS. 6 and 7 is a schematic view showing a system configuration of a data transmission system between railway cars according to a fifth embodiment of the present invention.

In each of FIGS. 6 and 7, a laid line 4 in each of the cars 100, 110 and 120 is connected with PLC modems 7, each of which is connected with a wireless access point 19.

In the embodiment of FIG. 6, a cellular phone 20 is set as a destination of communication from the wireless access point 19. In the embodiment of FIG. 7, a personal computer (PC) 21 is described as a destination of communication from the wireless access point 19.

The cellular phone 20 can directly call outside the car with an exception of the time when the car is outside the area for communicating waves such as in a tunnel or on a subway, that is, out of the communication zone. Then, the fifth embodiment enables the cellular phone 20 to communicate with outside even if it is outside the area for communicating waves as mentioned above by having the access point 19 relay the communication and using a communication unit with outside, which is provided for each of the cars 100, 110 and 120 over the PLC 7. A technique described in the fourth embodiment can be used as the communication unit with outside which is provided for the car.

As usage of PC through a wireless LAN has been broaden, a passenger in a car with the access point 19 of the wireless LAN being set, as in the embodiment of FIG. 7 can get an E-mail service and an internet service by a PC 21.

With a broadband wireless LAN, a passenger can get a motion picture service such as a video game provided by motion picture or a film as in the second embodiment. This enables a passenger to enjoy a railway travel.

Although the PLC technique, which uses an existing electric wire as a communication line without requiring a dedicated line, has been mainly described in the above mentioned embodiments, the existing line is not limited to an electric wire and may be the other existing lines only if it is an existing metal line, such as a cable for supplying power to railway cars or a signal control line already laid between cars.

Although many embodiments have been described mainly in conjunction with a railway car, the embodiments can be applied to a vehicle such as a liner or an airplane, or a construction such as a building with many floors and rooms.

Although each of the terminals 8 shown in FIG. 1 and each of terminals 9 shown in FIG. 2 are only shown in the figures and detailed description is omitted, the terminals can be substituted by the other terminals for the other various types of usage such as a telephone (an audio telephone, a television telephone), a personal computer, a personal video for distributing entertainment contents, an audiovisual apparatus, as well as various battery chargers, a telephone switchboard, a server, a transceiver, a receiver, various sensors for an internal interphone, and a control.

As mentioned above, the present invention can provide a transmission system for transmitting data between cars such as railways or subways, wherein the system uses existing lines such as an electric wire for supplying power to existing lights without laying dedicated lines to each car such as a communication line for transmitting image and audio information data, a control line for switching train type indications indicating the destination, limited express/express or the like or for controlling lights and air-conditioners, and a line for communicating signals from various sensors such as a detecting sensor, a temperature sensor, and a pressure sensor. Accordingly, the present invention can easily establish a high speed high bandwidth communication network. Thus, the present invention facilitates maintenance and management as it omits or simplifies a communication line by integrating a broadcasting function, a calling function, an emergency calling function, a guide display function and the like.

Therefore, the present invention enables an alternative appliance to substitute an existing appliance or a new appliance to be added to an existing appliance without changing laid lines even in a conventional existing car. If the PLC is adopted for the laid lines at the initial stage of manufacturing a newly constructed car, functions of the car can be easily upgraded without requiring the laid lines being changed to new lines. Thus, the present invention can facilitate streamlining inside a car and system upgrading.

Existing coupling sections, connectors and wiring inside a car or between cars, line materials inside a car can be used as they are for the PLC. Thus, the present invention eliminates cost for designing wiring and layout of a car and the manpower in changing the wiring and layout. Thus, the PLC can reduce a capital investment for new apparatuses in a car to a large extent. As the number of wires and laid lines are reduced, the weight of line materials becomes less, which realizes weight saving, simplifying and cost saving of a car.

By using the PLC, it becomes easier to combine or recombine various terminals, and to centralize program loading to the various terminals. In addition, the PLC can realize automatic checking of various terminals or automatic operation checking. By using the PLC, the present invention can coexist with the other network media such as the Ethernet and a wireless LAN. Moreover, the PLC is quite robust.

The PLC has a learning function packet and can always select a carrier frequency carrier in response to fluctuation of frequency. Therefore, the PLC can cut the carrier frequency carrier with reflection or noise of transmitted signals by determining adaptability of the carrier. Thus, the PLC is appropriate for a vehicle including a car which is prone to a sudden noise.

The embodiment also realizes weight saving and cost saving of a car by reducing the number of apparatuses as well as saving the number of wires. The PLC can also be easily adapted in establishing an access point of a wireless LAN. The PLC also facilitates recombination of apparatuses to be used.

It is advantageous to apply the embodiment to a railway car in that low resistant copper lines are used in view of energy transmission efficiency for electric wires and that a high frequency digital signal seldom affects transmission in a car as electronic wave leakage while the train is running as a train body is generally covered with metal such as iron or light weight aluminum alloy.

The PLC communication can be mounted for a railway car and the PLC communication can apply to any type of lines and enables high speed transmission (190 Mbps: use 2-30 MHz band). This can realize system construction such as broadcasting, information and advertisement distribution or security service, which is a so-called broadband network, inside a railway car or between railway cars. Accordingly, the embodiment can provide more sophisticated image and audio information service for servicing passengers on railways. The embodiment also facilitates communication between a railway car and a base station such as a station. The embodiment can realize integrated distribution and communication to all the passengers and all the staff at the same time.

### Sixth Embodiment

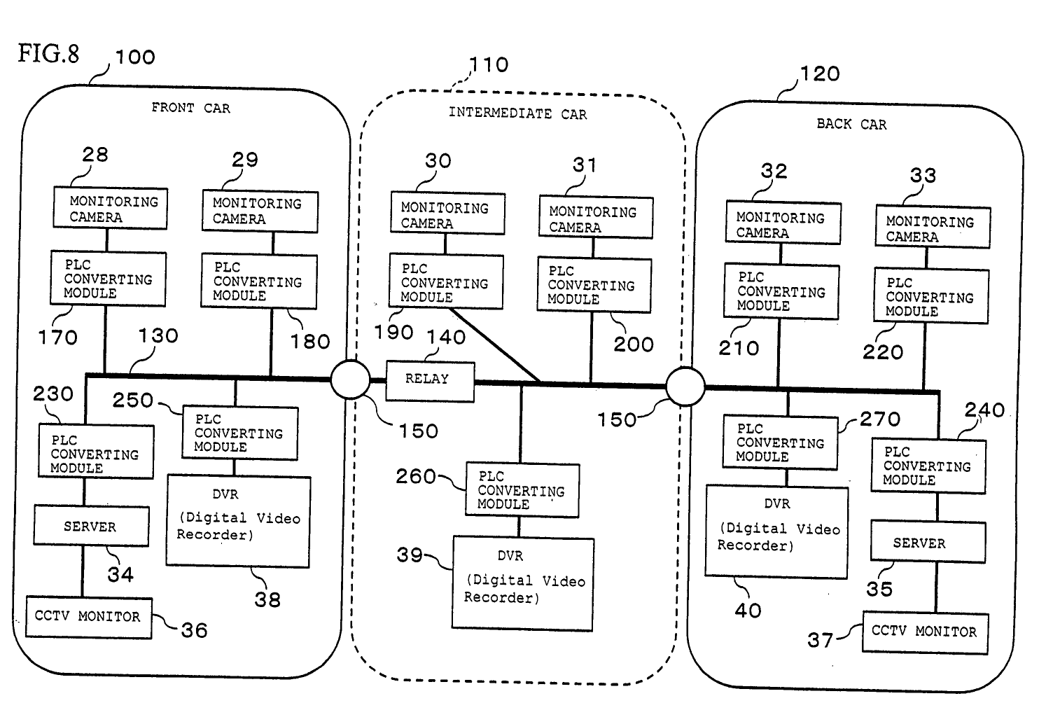

FIG. 8 shows a block diagram of a large amount of data transmission system between railway cars according to the sixth embodiment of the present invention. FIG. 8 shows an example of a basic configuration for transmitting a large amount of data.

As mentioned in the above described embodiments, railway cars include a front car 100, intermediate cars 110 consisting of some cars, and a back car 120 at the end. Although the intermediate car 110 is shown for a single car in FIG. 8, multiple cars of the intermediate cars 110 may be coupled between the front car 100 and the back car 120.

The large amount of data transmission system according to the sixth embodiment is set between the cars. The configuration of the sixth embodiment can be adapted to any lines such as a new communication line or an existing communication line.

Laid lines such as an electric wire for supplying power to each car and a conventional communication line for communicating are connected through the cars via relays 140 placed near coupling sections 150 of the respective cars. A communication line of the laid lines is an E1 communication line 130. E1 communication is performed between conventional communication-devices (not shown) placed in respective cars by using the E1 communication line 130.

Each of PLC converting modules 170-270 has a PLC modem and also has an A/D converting function and the like besides the modulating/demodulating function. Each of the PLC converting modules 170-270 is connected with an E1 communication line 130.

The E1 is a communication method which is generally used in the digital WAN in Europe. The E1 transmits by carrier frequency of 1 MHz at the speed of 2.048 Mbps.

The PLC communication has a feature of transmitting a signal modulated by using a plurality of carrier frequencies. The present invention is not limited to the communication via an electric wire using electric power. The present invention applies the feature of the PLC communication for transmitting a signal modulated by using the plurality of carrier frequencies to the communication via the E1 communication line 130 without using electric power.

In the front car 100, the PLC converting modules 170 and 180 are connected with monitoring cameras 28 and 29 respectively. Similarly in each of the intermediate cars 110, the PLC converting modules 190 and 200 are connected with monitoring cameras 30 and 31 respectively. In the back car 120, the PLC converting modules 210 and 220 are connected with monitoring cameras 32 and 33 respectively.

In the front car 100, the PLC converting module 230 is connected with a server 34 and a CCTV (Closed Circuit Television) monitor 36. Similarly in the back car, the PLC converting module 240 is connected with a server 35 and a CCTV monitor 37.

In each car, the PLC converting modules 250-270 are connected with DVRs (Digital Video Recorders) 3.8-40 respectively.

The monitoring cameras 28-33 are an example of a plurality of transmitting units of the present invention, while the servers 34, 35 and the DVRs 38-40 are an example of a plurality of receiving units of the present invention. The E1 communication line 130 is an example of the same cable, which is a metal laid line, of the present invention.

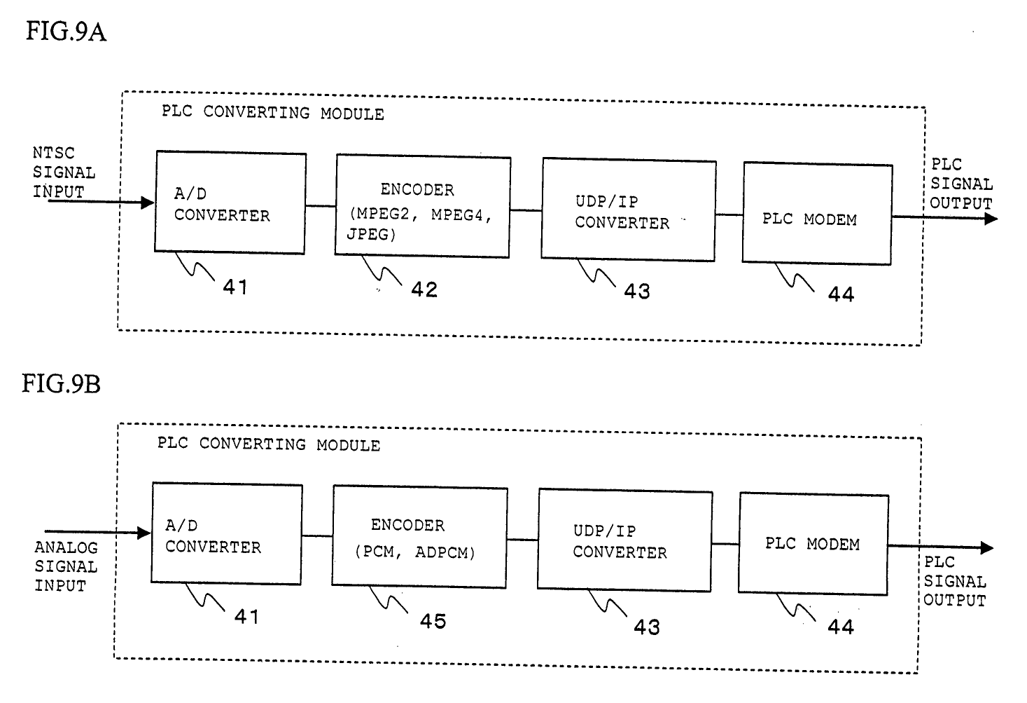

FIG. 9A shows an example of a configuration of the PLC converting modules 170-220.

An NTSC (National Television System Committee) signal input which is inputted from the monitoring cameras 28-33 is converted into a PLC signal through an A/D converter 41, an encoder 42, a UDP/IP (User Datagram Protocol/Internet Protocol) converting section 43 and a PLC modem 44. Then the PLC signal is outputted on the E1 communication line 130. If the input is a PLC signal and the NTSC signal is to be outputted, the modules decode the PLC signal and output the NTSC signal through the process inverse to the above mentioned process. The PLC modem 44 is a data modulation/demodulation section for digital data for performing PLC communication. When the PLC modem 44 sends data, it adds an error correction code to the data converted into digital data, performs process such as packetizing the digital data and the like and sends out the data.

FIG. 9B shows an example of a configuration of the PLC converting module when an input is an analog audio signal. By substituting an encoder 45 for processing audio data for the encoder 42 for processing image data shown in FIG. 9A, the embodiment can make the PLC converting module the PLC converting module for inputting an analog audio signal.

As the PLC converting modules 250-270 connected with the DVR 38-40 need no analog/digital conversion in FIG. 8, it can be realized by a configuration shown in FIG. 9A without the A/D converter 41.

The large amount of data transmission system according to the sixth embodiment realizes a large amount of data transmission by connecting a unit for sending and receiving a large amount of data with the E1 communication line 130 via the PLC converting modules, using a frequency band that is not used for the E1 communication for communicating PLC signals and using the existing E1 communication line 130.

The data transmission method will be described below with reference to FIGS. 8-11.

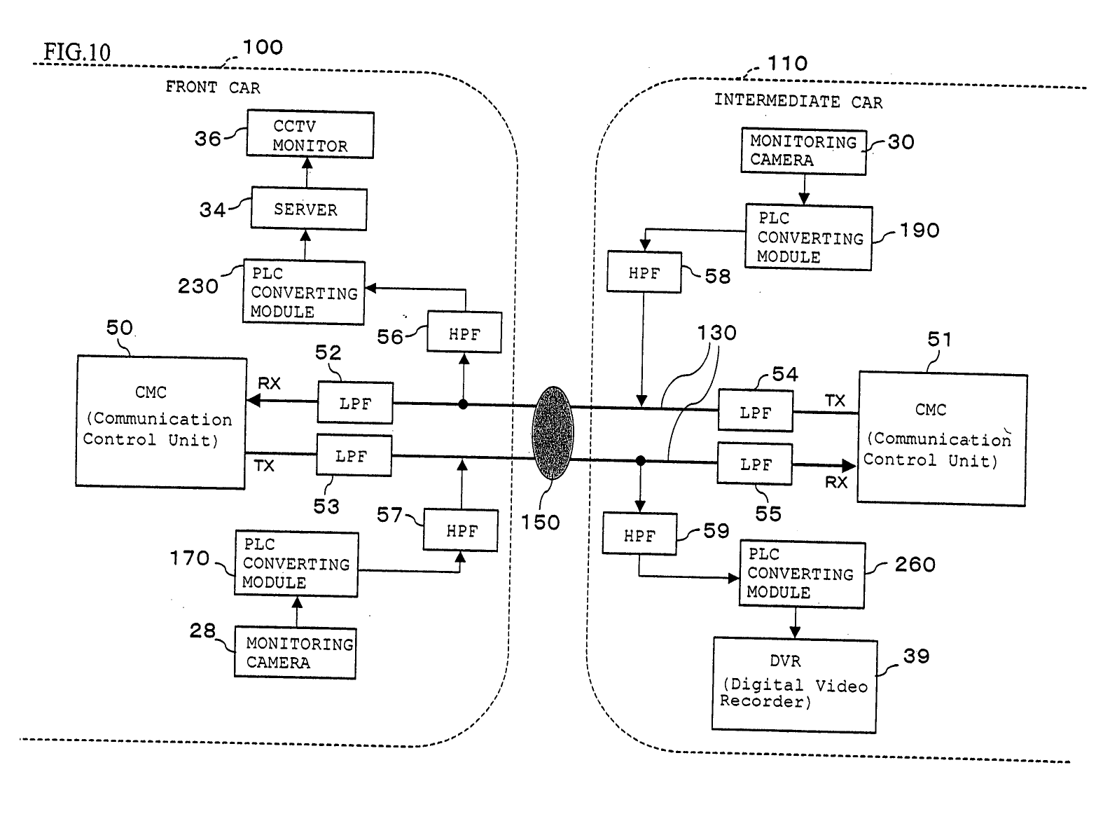

FIG. 10 shows a block diagram of a part of the large amount of data transmission system according to the sixth embodiment. FIG. 10 shows partial configurations of the front car 100 and the intermediate car 110 shown in FIG. 8. The same components as those in FIG. 8 are denoted by the same reference codes.

A CMC 50 and a CMC 51 are existing Communication Control Units which are provided for the front car 100 and the intermediate car 110 respectively. The CMC 50 and the CMC 51 perform the E1 communication with each other by using an E1 communication line 130. The E1 communication line 130 is provided for each direction of transmission as shown in FIG. 10.

The PLC converting modules 230, 190, 170 and 260 are connected with the E1 communication line 130 via HPFs (High Pass Filters) 56, 58, 57 and 59, respectively. The HPFs 56-59 are high-pass filters for suppressing signals in frequency bands used for the E1 communication between the CMCs so as not to pass through the E1 communication line 130.

The CMC 50 is connected with the E1 communication line 130 via LPFs (Low Pass Filters) 52 and 53. The CMC 51 is connected with the E1 communication line 130 via LPFs 54 and 55. The LPFs 52-55 are low-pass filters for suppressing signals in frequencies higher than the bands used for the E1 communication so as not to pass through the E1 communication line 130.

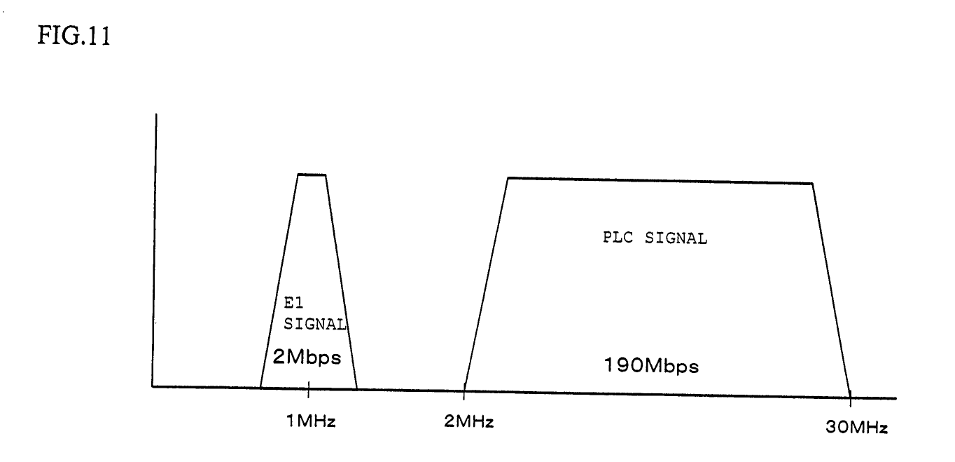

FIG. 11 shows an allocation of frequencies used for the E1 communication and the PLC communication on the E1 communication line 130 in the sixth embodiment.

The E1 signals are transmitted through the bands centered around 1 MHz. Each of the PLC converting modules 230, 190, 170 and 260 uses bands (2 MHz-30 MHz) higher than those used for the E1 signals for transmitting the PLC signals.

The embodiment makes the LPFs 52-55 low-path filters for suppressing signals in bands of 2 MHz or more to prevent the PLC signals using bands of 2 MHz or more from affecting the CMC 50 and the CMC 51 for performing the E1 communication. The embodiment makes the HPFs 56-59 high-path filters for suppressing signals in bands near 1 MHz or less used by the E1 signals to prevent the E1 signals from affecting the PLC converting modules 230, 190, 170 and 260 for performing the PLC communication.

Operation for transmitting a PLC signal from an intermediate car 110 to a front car 100 will be described below.

The E1 signals sent from the CMC 51 passes through an LPF 54 and only signals in the bands of 2 MHz or less are sent out on the E1 communication line 130. Image data sent from the monitoring camera 30 is converted into digital signals at the PLC converting module 190. Then the digital signals pass through the HPF 58 and is sent out on the E1 communication line 130. Accordingly, only signals in the bands of 2 MHz or more are sent out on the E1 communication line 130. In this way, the E1 signals in the bands near 1 MHz and the PLC signals in the bands of 2 MHz-30 MHz are superimposed and transmitted on the E1 communication line 130.

Signals superimposed on the E1 communication line 130 pass through the HPF 56 so that only the signals in the bands of 2 MHz or more are inputted into the PLC converting module 230. That is to say, only the PLC signals are inputted into the PLC converting module 230. Then the PLC signals are decoded at the PLC converting module 230 and the image data outputted from the monitoring camera 30 is inputted into the server 34 and the image is displayed on the CCTV monitor 36 placed in a cock pit of the front car 100.

Signals superimposed on the E1 communication line 130 pass through the HPF 52 so that only the signals in the bands of 2 MHz or less are inputted into the CMC 50. That is to say, only the E1 signals are inputted into the CMC 50. In this manner, audio information for business purpose can be communicated from a conductor in the intermediate car 110 to a driver in the front car 100.

The large amount of data transmission system according to the sixth embodiment provides the LPFs 52-55 and the HPFs 56-59 so that it can perform the E1 communication between the CMC 50 and the CMC 51 without being affected by a PLC signal and the PLC communication between the PLC converting module 190 and the PLC converting module 230 without being affected by an E1 signal.

In this manner, the embodiment can perform a conventional E1 communication in the transmission speed of 2 Mbps between the CMC 50 and the CMC 51 and a PLC communication in the high speed transmission of 190 Mbps between the PLC converting module 190 and the PLC converting module 230, by using the existing E1 communication line 130 without needing to lay a new cable of transmitting a large amount of data.

In the above description about data transmission from the intermediate car 110 to the front car 100, the monitoring camera 30 is an example of a transmitting unit of the present invention and the server 34 is an example of a receiving unit corresponding to a transmitting unit of the present invention. Similarly, the CMC 51 is an example of another transmitting unit of the present invention and the CMC 50 is an example of a receiving unit corresponding to another transmitting unit of the present invention.

Operation for transmitting data from an intermediate car 110 to a front car 100 has been described above. The system takes the same operation in transmitting image data from the monitoring camera 28 to the DVR 39 to transmit data from the front car 100 to the intermediate car 110 as the above described operation. Operation for communicating between any cars including the back car 120 is also the same as the above described operation.

Although the LPFs 52-55 are provided between the CMCs 50, 51 and the E1 communication line 130 in the sixth embodiment, the LPFs 52-55 can be provided in the CMCs 50, 51. Although the HPFs 56-59 are provided between each PLC converting module and the E1 communication line 130 in the sixth embodiment, the HPFs 56-59 can be provided in each PLC module.

Although the case where an E1 signal is superimposed on a PLC signal is described above, the signal superimposed by the PLC signal is not limited to the E1 signal. The present invention can also realize a large amount of data transmission by superimposing the PLC signal on any signal, only if the signal can be transmitted over a metal line.

For example, laid lines in a railway car include a laid line for analog audio signals over which an audio signal used for announcement on board a train or the like is transmitted.

If a laid line for an analog audio is substituted for the E1 communication line 130 in the configuration of FIG. 10, the PLC signal can be superimposed on an analog base band audio signal and transmitted by using the laid line for an analog audio.

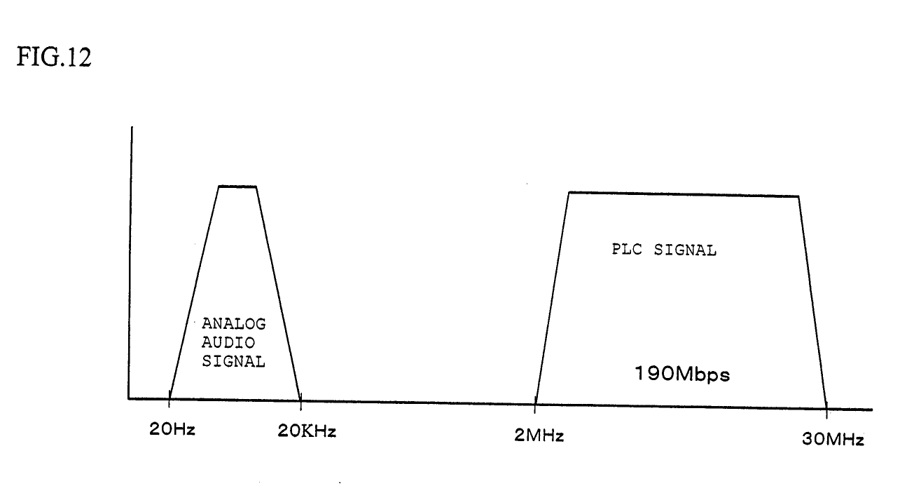

FIG. 12 shows an allocation of frequencies used for the analog audio communication and the PLC communication on the laid line for an analog audio when the PLC signal is superimposed on the analog base band audio signal.

As the bands used for the analog audio signals are 20 Hz-20 KHz, the LPFs 52-55 of FIG. 10 may be made low-pass filters for suppressing signals in frequency over 20 KHz, in this case.

In such a case, the analog audio signal may not affect the bands of 2 MHz or more, which are used for the PLC signal, and the PLC signal may not affect the bands of 20 KHz or less, which are used for the analog signal. Therefore, the LPFs 52-55 and the HPF 56-59 may be removed from the configuration of FIG. 10.

If a communication is performed via a metal line over the frequency other than the bands used for the PLC communication (2 MHz-30 MHz) such as the E1 communication (the bands centered around 1 MHz) or the analog audio communication (20 Hz-20 KHz), the large amount of data transmission method according to the sixth embodiment can be applied to a communication other than the E1 communication or the analog audio communication. The sixth embodiment can realize a large amount of data transmission through the PLC communication by superimposing the PLC communication on a communication such as a VHF communication (30 MHz-300 MHz), a UHF communication (300 MHz-3 GHz), a QAM communication (200 MHz-350 MHz), a low-speed PLC communication (below 500 KHz), an ADSL communication (below 1.1 MHz) or the like. It is a matter of course that the large amount of data transmission method according to the sixth embodiment can be applied to any communication in addition to the above communications, only if the communication is performed via a metal line in a frequency other than 2 MHz-30 MHz.

### Seventh Embodiment

A large amount of data transmission system between railway cars according to the seventh embodiment of the present invention will be described below. Although a block diagram of the entire large amount of data transmission system according to the seventh embodiment is the same as that of the sixth embodiment shown in FIG. 8, the transmission method according to the seventh embodiment is different from that of the sixth embodiment.

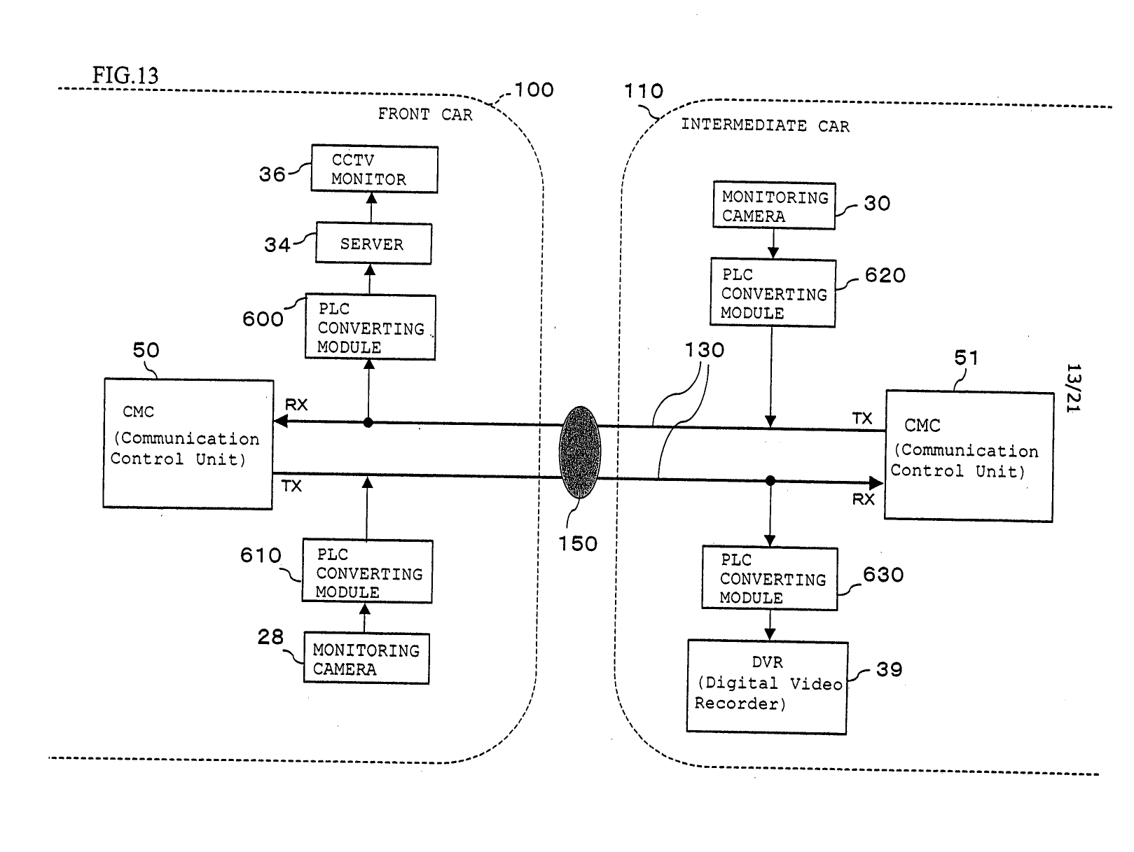

FIG. 13 shows a block diagram of a part of a large amount of data transmission system according to the seventh embodiment. FIG. 13 shows partial configurations of the front car 100 and the intermediate car 110 shown in FIG. 8. The same components as those in FIG. 8 are denoted by the same reference codes. Although FIG. 13 shows components corresponding to those shown in FIG. 10, the embodiment shown in FIG. 13 realizes a large amount of data transmission in a configuration without a filter, as different from the embodiment shown in FIG. 10.

Each PLC modem included in the PLC converting modules 600-630 of the large amount of data transmission system according to the seventh embodiment can be adapted to preset the bands used for the PLC communication.

The E1 communication is performed by not only using the bands near 1 MHz but also using the bands of higher harmonic waves, such as the bands near 3 MHz, near 5 MHz, near 7 MHz or the like. The large amount of data transmission system according to the seventh embodiment is for performing a PLC communication without affecting the bands of higher harmonic waves used in the E1 communication.

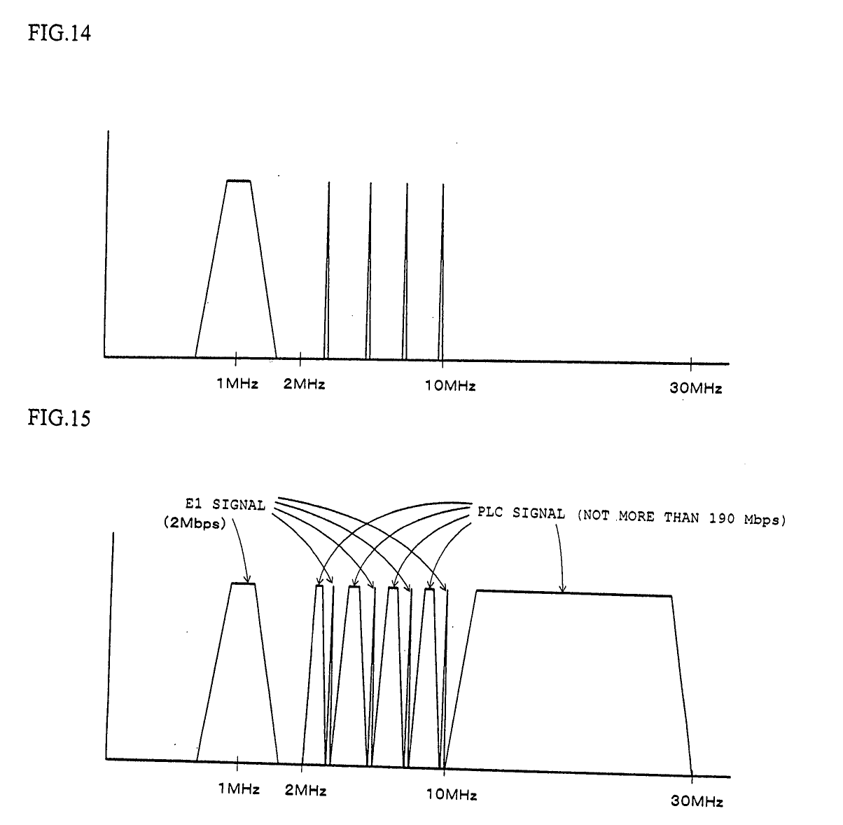

FIG. 14 shows an example of frequency bands used for the E1 communication. As shown in the figure, plural bands distributed in the form of discontinuous tooth of a comb including the bands of higher harmonic waves other than 1 MHz are used in the E1 communication.

FIG. 15 shows an allocation of frequencies used for the E1 communication and the PLC communication on the E1 communication line 130 in the seventh embodiment. In the seventh embodiment, each band between discontinuous bands used for the E1 communication is used for the PLC communication. That is to say, the PLC communication according to the seventh embodiment uses discontinuously distributed frequency bands as shown in FIG. 15.

The discontinuous bands used for the E1 communication shown in FIG. 14 are fixed bands predetermined for the system. Therefore, each of the PLC modems of the PLC converting modules 600-630 are preset for using the bands other than the discontinuous bands used for the E1 communication for the PLC communication.

Operation for transmitting a PLC signal from an intermediate car 110 to a front car 100 will be described below.

An E1 signal sent from a CMC 51 is sent out on the E1 communication line 130 as it is. That is to say, signals of discontinuous bands shown in FIG. 14 are sent out on the E1 communication line 130. Image data sent from a monitoring camera 30 is converted into digital signals at a PLC converting module 620 and the digital signals are sent out on the E1 communication line 130. Here, the PLC converting module 620 sends out a PLC signal in the bands preset for the PLC modem, i.e., the bands other than those used for the E1 communication. Therefore, the PLC signals are sent out in the discontinuous bands used for the PLC signals shown in FIG. 15.

As a result, the E1 signals which use the discontinuous bands and the PLC signals which use the discontinuous bands are superimposed without using the same bands as shown in FIG. 15 and transmitted on the E1 communication line 130.

As the CMC 50 processes only signals of predetermined fixed bands used for the E1 communication as the E1 signals, the CMC 50 processes only the signals allocated to the E1 signals among the bands shown in FIG. 15.

A PLC modem of a PLC converting module 600 is set to receive PLC signals in preset bands other than the bands used for the E1 communication. Therefore, the PLC modem processes only the signals allocated to the PLC signals in the bands shown in FIG. 15 among signals superimposed on the E1 communication line 130. Then the signals are decoded in the PLC converting module 600 and the image data outputted from a monitoring camera 30 is inputted into a server 34 and the image is displayed on a CCTV monitor 36.

In this manner, as the large amount of data transmission system according to the seventh embodiment transmits the PLC signals by using only the bands other than those used for the E1 communication, the system can perform high speed PLC transmission without affecting the E1 communication.

The large amount of data transmission system according to the seventh embodiment can realize high speed transmission for an existing component of the E1 communication between the CMC 50 and the CMC 51 without changing the configuration by adding a filter to the configuration or the like. Therefore, the system can be easily constructed from an existing system configuration.

Although the seventh embodiment has been described in an example where the PLC signal is superimposed on the E1 signal by using the E1 communication as a second communication in the present invention, the signal superimposed by the PLC signal is not limited to the E1 signal. The PLC signals can superimpose on any signal only if the signal is transmitted over a metal line.

If the second communication is a predetermined communication other than the E1 communication, it is a matter of course that distribution of allocated frequencies shown in FIG. 15 is different from the above description. Even in such a case, the present invention can realize a large amount of data transmission by the PLC communication without being affected by a predetermined communication and without affecting a predetermined communication, by allocating frequencies other than those are not used for the predetermined communication to frequencies used for the PLC communication in the same method as described in the example of the E1 communication.

### Eighth Embodiment

Now, a large amount of data transmission system between railway cars according to the eighth embodiment of the present invention will be described.

A configuration of the large amount of data transmission system according to the eighth embodiment is the same as that of the seventh embodiment shown in FIGS. 8 and 13. The bands allocated for the E1 communication and the PLC communication are the same as those of the second embodiment shown in FIG. 15.

The large amount of data transmission system according to the eighth embodiment is different from that according to the seventh embodiment in a way of determining the frequency band used for the PLC communication. In the seventh embodiment, information on the bands used for the PLC communication is preset in the PLC modem included in the PLC converting module. In the eighth embodiment, a PLC modem of a PLC converting module determines the bands used for the E1 communication and performs the PLC communication by using the bands other than the determined band.

The PLC communication is a packet communication and can detect information on a signal level on a transmission channel from a header part of the packet. A transmission channel is also estimated from the information on a signal level obtained from the header part in a typical LAN. Therefore, the PLC modem also has the same function.

Operation for transmitting a PLC signal from an intermediate car 110 to a front car 100 will be described below.

In FIG. 13, a PLC modem of a PLC converting module 620 determines the frequency bands used for the E1 communication from header information of the received packet data. The PLC modem can determine whether the signal is that used for E1 or a noise by previously setting an appropriate threshold for a signal level and comparing a signal level obtained from the header information with the previously set threshold.

When the PLC modem of the PLC converting module 620 determines that the discontinuous bands as shown in FIG. 14 are used for the E1 communication, the PLC modem thereafter sends and receives PLC signals by using the bands other than those determined as used for the E1 communication. That is to say, the PLC modem sends and receives the PLC signals by using the discontinuous bands shown as frequencies used for the PLC signals in FIG. 15. The same process is performed in the other PLC converting modules 600, 610 and 630.

E1 signals sent form a CMC 51 are sent out on an E1 communication line 130 as they are in the same manner as in the seventh embodiment. That is to say, signals of discontinuous bands shown in FIG. 14 are sent out on the E1 communication line 130. Image data sent from a monitoring camera 30 is converted into digital signals at a PLC converting module 620 and the digital signals are sent out on the E1 communication line 130. Here the PLC modem of the PLC converting module 620 sends out the PLC signal in the bands other than the bands determined as used for the E1 communication. That is to say, the PLC modem sends out the PLC signal in the discontinuous bands used for the PLC signals shown in FIG. 15.

As a result, the E1 signals which use the discontinuous bands and the PLC signals which use the discontinuous bands are superimposed without using the same bands as shown in FIG. 15 and transmitted on the E1 communication line 130.

As the CMC 50 processes only signals of predetermined fixed bands used for the E1 communication as the E1 signals, the CMC 50 processes only the signals allocated for the E1 signals among the bands shown in FIG. 15.

A PLC modem of a PLC converting module 600 receives signals of the bands other than those determined as used for the E1 communication as the PLC signals. Therefore, the PLC modem processes only signals allocated to the PLC signals in the bands shown in FIG. 15 among the signals superimposed on the E1 communication line 130. Then the signals are decoded at the PLC converting module 600 and the image data outputted from a monitoring camera 30 is inputted into a server 34 and the image is displayed on a CCTV monitor 36.

The PLC modem of the PLC converting module 620 may at any timing determine the bands used for the E1 communication from header information of the received packet data. As the header part of the packet data received by the PLC communication always includes information on a signal level on the transmission channel, the PLC modem may always determine the bands, or the PLC modem may preset data for determining the frequency and determine the bands when it receives data returned in response to sending the data.

In the large amount of data transmission system according to the eighth embodiment, the PLC modem of each PLC converting module automatically determines the bands used by the E1 signals and decides the bands used for the PLC signal. Therefore, the system is easily placed in the existing facility without requiring any setting after the system is placed.

Although the eighth embodiment is described by using an example where the PLC signal is superimposed on the E1 signal by using the E1 communication as the second communication of the present invention, as the seventh embodiment is, the PLC signal is not limited to be superimposed on the E1 signal. The PLC signal may be superimposed on any signal only if the signal can be transmitted over a metal line.

### Ninth Embodiment

Now, a large amount of data transmission system according to the ninth embodiment of the present invention will be described.

For simplicity of the description, in the sixth to the eighth embodiments, the frequency bands used in the PLC communication have been described as using all the frequencies in the continuous bands. Practically, however, the PLC communication is performed by using the bands which are divided into plural parts in the range of 2 MHz-30 MHz.

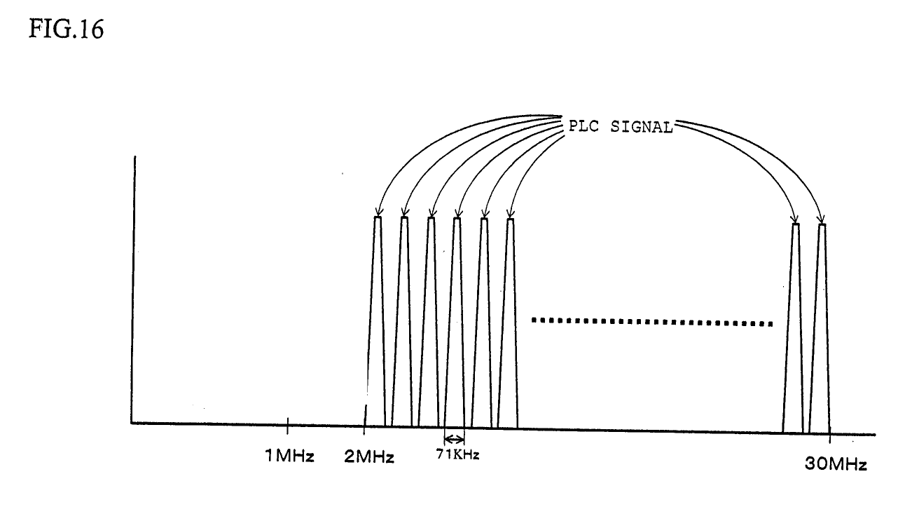

FIG. 16 shows an example of the bands used in the PLC communication. As shown in the figure, the PLC communication is performed by using the discontinuous bands separated by about 71 KHz in a range of 2 MHz-30 MHz. The large amount of data transmission system according to the ninth embodiment is for transmitting a PLC communication and the other communication by allocating the unused frequencies between discontinuous bands used in the PLC communication to the frequencies used in the other communication and superimposing the PLC communication on the other communication.

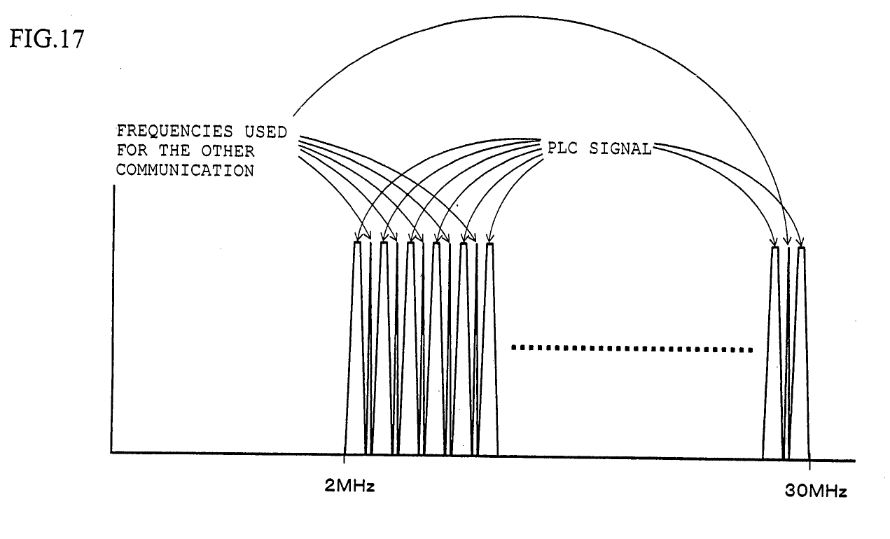

FIG. 17 shows distribution of frequency bands used in the other communication, which are superimposed on the PLC communication, in the large amount of data transmission system according to the ninth embodiment. In the large amount of data transmission system according to the ninth embodiment, frequencies distributed in the form of tooth of a comb between bands of about 71 KHz widths used in the PLC communication (unused frequencies in the PLC communication) are allocated to the frequencies used in the other communication and used, as shown in FIG. 17.

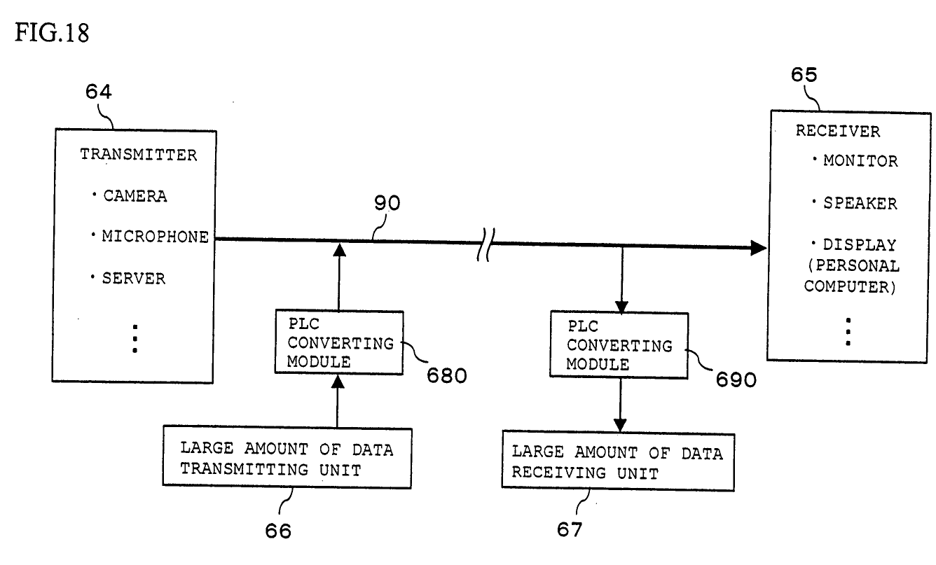

FIG. 18 shows a block diagram of the large amount of data transmission system according to the ninth embodiment.

A transmitter 64 transmits data to a receiver 65 by a communication other than the PLC communication via a metal line cable 90, i.e., by the other communication. The transmitter 64, a device of sending a small amount of data, is such as a camera, a microphone or a server. The receiver 65, a device of receiving a small amount of data, is such as a monitor, a speaker, or a display of a personal computer.

A large amount of data transmitting unit 66 is a device of sending a large amount of data, and connected with a cable 90 via a PLC converting module 680. A large amount of data receiving unit 67 is a device of receiving a large amount of data, and connected with a cable 90 via a PLC converting module 690.

The large amount of data transmitting unit 66 sends a large amount of data to the large amount of data receiving unit 67 by the PLC communication by using the cable 90 used for the other communication between the transmitter 64 and the receiver 65. That is to say, data transmitted by the PLC communication and the data transmitted by the other communication are superimposed on the cable 90 and transmitted.

The PLC communication is an example of the first communication of the present invention and the other communication is an example of the second communication of the present invention.

The large amount of data transmission system according to the ninth embodiment will be described below by exemplifying a case where the E1 communication is used as the other communication.

Block diagrams showing the entire of and a part of the large amount of data transmission system according to the ninth embodiment in the case where the E1 communication is used as the other communication are the same as those of the seventh embodiment shown in FIGS. 8 and 13.

In such a case, the CMC 50 and the CMC 51 in FIG. 13 correspond to the transmitter 64 and the receiver 65 of FIG. 18, respectively. The monitoring camera 30 and the monitoring camera 28 correspond to the large amount of data transmitting unit 66, and the server 34 and the DVR 39 correspond to the large amount of data receiving unit 67. The PLC converting modules 610 and 620 correspond to the PLC converting module 680 and the PLC converting modules 600 and 630 correspond to the PLC converting module 690. The E1 communication line 130 corresponds to the cable 90.

The example of the large amount of data transmission system according to the ninth embodiment using the E1 communication as the other communication is different from that of the seventh embodiment in allocation of frequency bands used in the E1 communication and frequency bands used in the PLC communication.

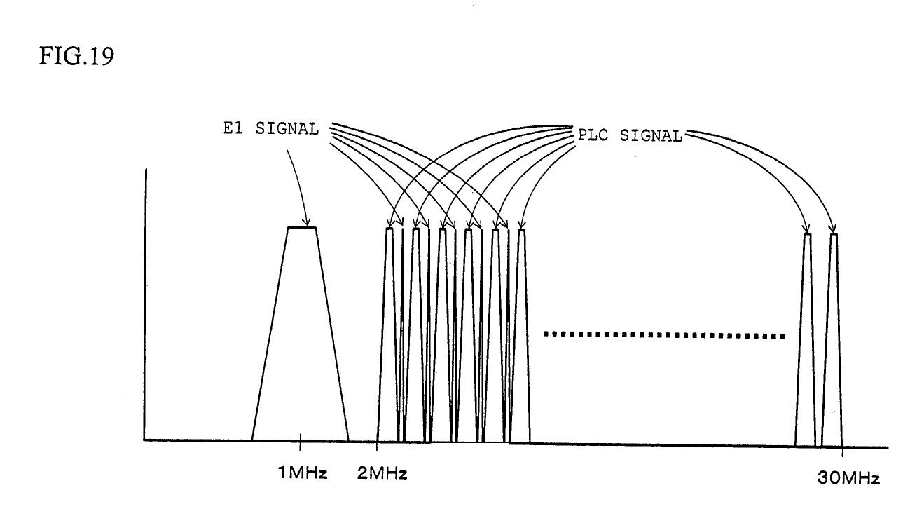

FIG. 19 shows an allocation of frequencies used in the E1 communication and the PLC communication on the E1 communication line 130 in the ninth embodiment. In the ninth embodiment, frequencies between the discontinuous bands used in the PLC communication are used in the E1 communication. That is to say, distribution of frequencies used in the PLC communication shown in FIG. 19 is the same as that of frequencies shown in FIG. 16, and frequencies between the bands used in the PLC communication are allocated to the frequencies used for the E1 signals. Therefore, in the bands of 2 MHz or more which are used both in the E1 communication and the PLC communication, the E1 communication and the PLC communication are performed by using discontinuously distributed frequency bands as shown in FIG. 19.

The discontinued bands used in the PLC communication as shown in FIG. 16 are fixed bands predetermined for the system. Therefore, the bands other than the discontinuous bands used for the PLC communication are preset to be used in the E1 communication for the CMC 50 and the CMC 51.

Operation for transmitting a PLC signal from an intermediate car 110 to a front car 100 will be described below with reference to FIG. 13.

Image data sent from a monitoring camera 30 is converted into digital signals at a PLC converting module 620 and the digital signals are sent out on an E1 communication line 130 as they are. When E1 signals are sent out on the E1 communication line 130, a CMC 51 sends out the E1 signals in the bands preset for the CMC 51, i.e., the bands other than that used for the PLC communication. Therefore, the E1 signals are sent out in the discontinuous bands allocated to the E1 signals shown in FIG. 19.

As a result, the E1 signals which use the discontinuous bands and the PLC signals which use the discontinuous bands are superimposed without using the same bands as shown in FIG. 19 and transmitted on the E1 communication line 130.

As a PLC modem of a PLC converting module 600 processes only signals in the predetermined fixed bands for being used in the PLC communication as shown in FIG. 16 as PLC signals, the PLC modem processes only the signals allocated to the PLC signals in the bands shown in FIG. 19. Then the signals are decoded in the PLC converting module 600, and image data outputted from a monitoring camera 30 is inputted into a server 34 and the image is displayed on a CCTV monitor 36.

As the CMC 50 is set to receive the E1 signals in the preset bands other than those used in the PLC communication, the CMC 50 processes only the signals allocated to the E1 signals of the bands shown in FIG. 19 among the signals superimposed on the E1 communication line 130.

In this method, as the E1 signals are transmitted by only using the bands other than those used for the PLC communication in the large amount of data transmission system according to the ninth embodiment, the system can perform high speed PLC transmission without being affected by the E1 communication.

Although the E1 communication is described as the other communication here, the PLC signal is not limited to be superimposed on the E1 signal. The PLC signal may be superimposed on any signal by applying the large amount of data transmission method according to the ninth embodiment only if the signal can be transmitted over a metal line.

Even for the communication other than the E1 communication (bands centered around 1 MHz) the PLC signals can be superimposed on such signals using frequencies in the range of the bands (2 MHz-30 MHz) used in the PLC communication such as the NTSC signal transmission (bands centered around 3.58 MHz) or the PAL (Phase Alternation by Line) signal transmission (bands centered around 4.43 MHz) and transmit. The large amount of data transmission method according to the ninth embodiment can be applied to any communications only if the communications use any frequency in the range of 2 MHz-30 MHz and they are performed via a metal line.

Although the PLC signals are described as being superimposed and used on the existing E1 communication line in each of the above mentioned embodiments, the PLC signals can be superimposed on the other existing communication lines or a control line.

As mentioned above, the data transmission system of the present invention enables an existing E1 communication line to be used as a communication infrastructure as it is so that the system can easily establish an additional communication network without laying a new cable.

The PLC communication is highly scalable as it has a feature available for any line. For example, the PLC communication can be easily changed to use a lamp line in future after the PLC signals are superimposed on the E1 communication line and operated.

According to the present invention, a data transmission system and a data transmission method of transmitting a large amount of data by using an existing cable facility can be provided.

### Tenth Embodiment

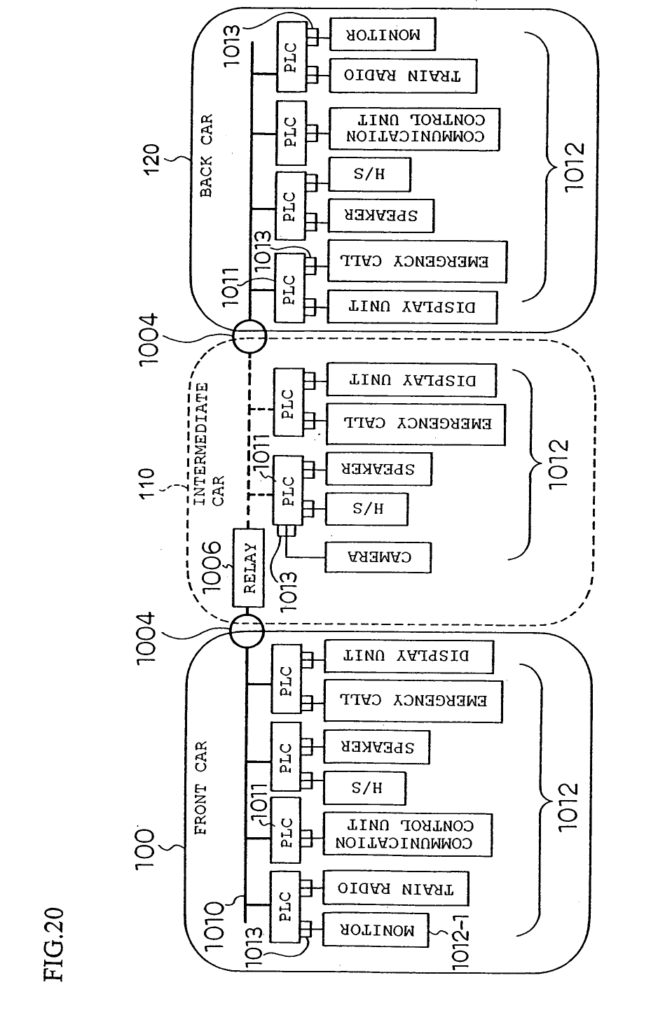

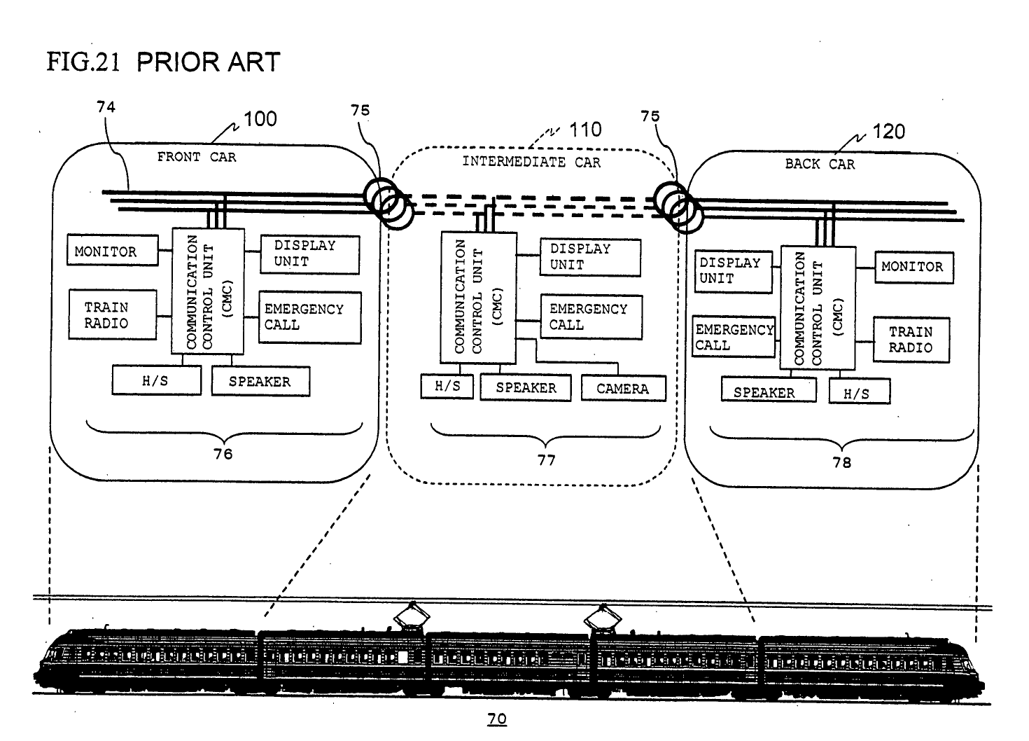

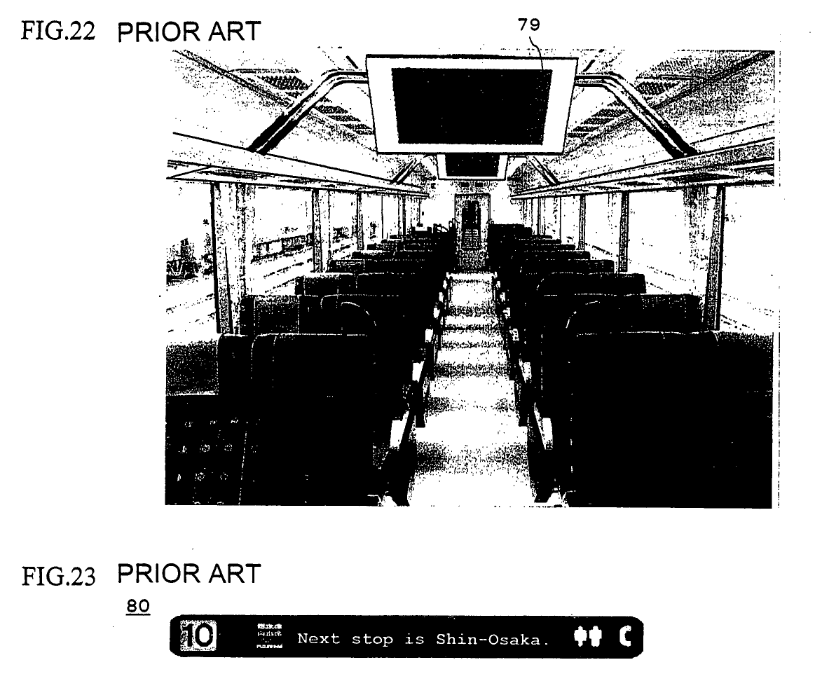

FIG. 20 is a network diagram according to the tenth embodiment of the present invention. The cars 100, 110 and 120 are coupled with each other and also electrically connected with each other. The electrical connection can be manually performed by a person connecting the connectors provided for each of the coupling sections 1004 or automatically and electrically performed when the cars are mechanically coupled with each other by using an electrical coupler (EP).

A laid line 1010 formed by an electric wire for PLC signals to flow through are provided in each car. Each of the laid lines 1010 is connected with various terminals 1012 as those described in the abovementioned embodiments via a PLC modem 1011. The laid lines 1010 are connected via relays 1006 placed near the coupling section 1004 of each car.

Each terminal 1012 is connected with a control unit 1013, which has a unique address (IP). The control unit 1013 is formed by a computer, for example. The control unit 1013 can store various types of information, manage each terminal 1012, and also manage exchange of data between terminals 1012.

The control unit 1013 also has a function of resetting each of the unique addresses of couplings between cars used till then and authenticating couplings anew and allocating or being allocated to a new unique address to each of the couplings when the couplings between the cars are changed.

When the front car 100 and the back car 120 are exchanged and coupled with each other anew where a control unit 1013 provided for a monitor 1012-1 of the car 100 is responsible for functioning as a master for each terminal and the other terminals are slave in the coupling state of FIG. 20, laid lines 1010 are also automatically and electrically connected with each other by electrical couplers (EPs) automatically.

When a control unit which communicated a telegraphic message of application for registration as a master in the first place is a control unit 1013 of the terminal, the control unit 1013 becomes a master and automatically authenticates each of the other control units 1013 and allocates a unique address (IP) to each of the other control units 1013.

When couplings between cars are changed in this manner, the couplings are automatically authenticated and addresses of respective terminals are allocated anew by the control unit 1013. The allocated new addresses are used in exchanging and managing various types of data between terminals.

As another modification, the system may preset a server function in a control unit of a particular terminal of a particular car (for example, a control unit of a Communication Control Unit) so that the particular control unit of the terminal having the server function can automatically authenticate the other control units and allocate addresses for the control units anew when the couplings between cars are changed. For example, the system can use a DHCP function of a LAN.

As yet another modification, the system may allow an administrator of a car to manually set individual addresses for respective control units anew.

According to the embodiment, each car can automatically authenticate a control unit of each other and unique addresses can be allocated, even if couplings between cars are changed.

The data transmission system between railway cars according to the present invention is useful for a data transmission system between railway cars such as railways or subways, for example, with the advantages in that the system can easily establish a high speed high bandwidth digital data transmission communication network by using existing laid lines such as an electric wire or the like, and facilitate maintenance and management by omitting or simplifying communication lines.

What is claimed is:

1. A data transmission system comprising:
an electric wire provided in a car;
a PLC modem connected with said electric wire; and
a terminal connected with said PLC modem;
wherein said terminal can communicate through said electric wire by using said PLC modem.

2. The data transmission system according to claim 1,
wherein said system comprises a plurality of said cars, a plurality of said PLC modems and a plurality of said terminals;
further comprising a control unit with a unique address, provided for each of said terminals; and
wherein, when said cars are coupled with each other, said electric wires are electrically connected with each other and a new address is allocated to each of said control units.

3. The data transmission system according to claim 2, wherein, when said cars are coupled with each other, said new address is automatically allocated to each of said control units by making any one of said control units as a master and the other control units as slaves according to a predetermined rule.

4. The data transmission system according to claim 2, wherein, when said cars are coupled with each other, a predetermined particular control unit assumes a server function and automatically allocates a new address to each of the other control units.

5. The data transmission system according to claim 2, wherein electrical connection between said electric wires in said plurality of cars is automatically completed.

6. A data transmission system comprising:
a line made of at least a single system of metal line provided in separated plural rooms;
two or more terminals of providing an image and audio information service for said rooms; and
a converting adapter connected between said line and said terminals; wherein said converting adapter modulates data into digital signals as electronic signals, sends the digital signals through said line when said data is sent from said terminals; and demodulates said digital signals and distributes said data to said terminals when said data is received.

7. The data transmission system according to claim 6, wherein said line is an electric wire laid in each car of a railway.

8. The data transmission system according to claim 6, wherein said separated rooms are railway cars.

9. The data transmission system according to claim 6, wherein said converting adapter is a PLC (Power Line Communications) modem.

10. The data transmission system according to claim 6, further comprising:
a converter of converting or inverting plural systems of signals into a single system of signals;
a PLC modem;
a connecting section of connecting said converter and said plural systems of signals.

11. The data transmission system according to claim 9, comprising:
the line including a communication line, a control line and an electric wire;
the PLC modem of superimposing a signal on said electric wire of said line; and
a connecting section of connecting said electric wire of said line and an electric wire of the other car through which a PLC signal flows.

12. The data transmission system according to claim 9, further comprising:
a PLC wireless signal converter connected to a line through which a PLC signal flows; wherein said PLC wireless signal converter separates a superimposed PLC signal and converts the PLC signal into wireless waves, or to the contrary receives wireless waves, converts the wireless waves into a PLC signal and superimposes the PLC signal on the line; and
an antenna of sending and receiving a wireless wave.

13. The data transmission system according to claim 9, further comprising a wireless access point connected with said PLC modem, wherein said wireless access point relays between a wireless communication device and said PLC modem.

14. A data transmission system in a transporting vehicle comprising:
a plurality of transmitting units; and
a plurality of receiving units corresponding to said plurality of transmitting units, respectively;
wherein a first communication between a transmitting unit and a receiving unit corresponding to said transmitting unit is performed by using a frequency different from that of a second communication and by at least partially using the same cable, the second communication being between another transmitting unit and a receiving unit corresponding to said other transmitting unit.

15. The data transmission system according to claim 14, wherein
said same cable is a laid line made of a metal line;
said second communication is a predetermined communication using said laid line;
said first communication is a communication using a plurality of carrier frequencies through said laid line; and
a modem for a first communication is provided between said transmitting unit and said laid line and between said receiving unit corresponding to said transmitting unit and said laid line.

16. The data transmission system according to claim 15,
wherein said first communication is a PLC communication (Power Line Communications); and
wherein a modem for said first communication is a PLC modem.

17. The data transmission system according to claim 16,
wherein said second communication is a E1 communication;
wherein said other transmitting unit and said receiving unit corresponding to said other transmitting unit are respectively connected with said laid line via a low-pass filter of reducing frequency bands used for a PLC communication; and
wherein each of said PLC modems is connected with said laid line via a high-pass filter of reducing frequency bands used for a E1 communication.

18. The data transmission system according to claim 16,
wherein said second communication is an E1 communication; and
wherein said PLC communication is performed by using frequency bands unused for said E1 communication.

19. The data transmission system according to claim 16, wherein said PLC modem connected with said transmitting unit determines frequency bands used for said second communication based on information of a header part of packet data received in said PLC communication, then performs said PLC communication by using frequency bands other than said bands used for said second communication.

20. The data transmission system according to claim 15, wherein said first communication is performed by using predetermined frequency bands except for fixed bands used for said second communication.

21. The data transmission system according to claim 15, wherein said second communication is performed by using frequency bands unused for said first communication.

22. The data transmission system according to claim 14, wherein said same cable is a laid line made of a metal line;
wherein said second communication is an analog audio communication using said laid line;
wherein said first communication is a communication of transmitting over a plurality of modulated carrier frequencies using said laid line; and
wherein a modem for a first communication is provided between said transmitting unit and said laid line and between said receiving unit corresponding to said transmitting unit and said laid line, respectively.

23. A data transmission system comprising:
a plurality of transmitting units;
a plurality of receiving units corresponding to said plurality of transmitting units respectively;
the same cable to which all of said plurality of transmitting units and said plurality of receiving units are connected;
a modem provided between a transmitting unit and said same cable; and
another modem provided between a receiving unit corresponding to said transmitting unit and said same cable; and
wherein a first communication between said transmitting unit and said receiving unit corresponding to said transmitting unit is performed by using frequency bands other than a plurality of discontinuous bands used for a second communication between an other transmitting unit and a receiving unit corresponding to said other transmitting unit.

24. The data transmission system according to claim 23, wherein said bands used by said first communication is predetermined bands except for fixed bands used for said second communication.

25. A data transmission method in a transporting vehicle,
wherein a first communication between a transmitting unit and a receiving unit corresponding to said transmitting unit is performed by using a frequency different from that of a second communication and by at least partially using the same cable, the second communication being between another transmitting unit and a receiving unit corresponding to said other transmitting unit.

26. A data transmission method comprising:
a plurality of transmitting units;
a plurality of receiving units corresponding to said plurality of transmitting units respectively;
the same cable to which all of said plurality of transmitting units and said plurality of receiving units are connected;
a modem provided between a transmitting unit and said same cable; and
another modem provided between a receiving unit corresponding to said transmitting unit and said same cable;
wherein a first communication between said transmitting unit and said receiving unit corresponding to said transmitting unit is performed by using frequency bands other than a plurality of discontinuous bands used for a second communication between another transmitting unit and the receiving unit corresponding to said other transmitting unit.
